(19) United States
(12) Patent Application Publication
(10) Pub. No.: US 2025/0317629 A1
(43) Pub. Date: Oct. 9, 2025

(54) SYSTEMS AND METHODS FOR GENERATING AN INTERACTIVE DISPLAY FOR AN EVENT SEQUENCE

(71) Applicant: STATS LLC, Chicago, IL (US)

(72) Inventors: Madison Rose HOM, London (GB); Briggs Patrick Clinard, New Orleans, LA (US); James Coverdale, Limerick (IE)

(73) Assignee: STATS LLC, Chicago, IL (US)

(21) Appl. No.: 19/098,746

(22) Filed: Apr. 2, 2025

Related U.S. Application Data
(60) Provisional application No. 63/574,420, filed on Apr. 4, 2024.

(51) Int. Cl. H04N 21/81; H04N 21/478

(52) U.S. Cl. CPC H04N 21/8133; H04N 21/478

(57) ABSTRACT

According to systems and techniques disclosed herein, a method for generating an interactive display may include receiving a plurality of real-time event data comprising a plurality of real-time event actions associated with a game identifier. The method may further include generating an event sequence based on the plurality of real-time event actions. The method may further include generating the interactive display including at least a graphical representation of the event sequence. The graphical representation of the event sequence may include one or more real-time event elements, and one or more interactive elements. The one or more interactive elements may be configured to cause the interactive display to update the one or more real-time event elements in response to one or more user interactions. The method may further include transmitting, to a user interface, the interactive display.

### CROSS-REFERENCE TO RELATED APPLICATIONS

This application claims priority to U.S. Provisional Application No. 63/574,420, filed Apr. 4, 2024, which is hereby incorporated by reference in its entirety.

### TECHNICAL FIELD

Various embodiments of this disclosure relate generally to computer-implemented techniques for generating an interactive display for an event sequence, and, more particularly, to systems and methods for generating an interactive display for an event sequence including real-time event elements.

### BACKGROUND

Filtering game-based data may generally be restricted to set time limits (e.g., the first half and second half of a soccer match), or may be based on a particular time code (e.g., 10:09 of the first quarter of the game). Such filtering does not include a unique visual timeline including real-time event elements that allows users to manipulate game-based data in a fully customizable way.

Unless otherwise indicated herein, the materials described in this section are not prior art to the claims in this application and are not admitted to be prior art, or suggestions of the prior art, by inclusion in this section.

### SUMMARY OF THE DISCLOSURE

In one aspect, an exemplary embodiment of a method for generating an interactive display may include receiving a plurality of real-time event data comprising a plurality of real-time event actions associated with a game identifier. The method may further include generating an event sequence based on the plurality of real-time event actions. The event sequence may be generated in real-time as the plurality of real-time event data is received. The method may further include generating the interactive display including at least a graphical representation of the event sequence. The graphical representation of the event sequence may include one or more real-time event elements, and one or more interactive elements. The interactive display may be formatted in real time as the plurality of real-time event data is received. The one or more interactive elements may be configured to cause the interactive display to update the one or more real-time event elements in response to one or more user interactions. The method may further include transmitting, to a user interface, the interactive display.

In another aspect, an exemplary embodiment of a system for generating an interactive display includes a memory storing instructions and a processor operatively connected to the memory and configured to execute the instructions to perform operations. The operations may include receiving a plurality of real-time event data comprising a plurality of real-time event actions associated with a game identifier. The operations may further include generating an event sequence based on the plurality of real-time event actions. The event sequence may be generated in real-time as the plurality of real-time event data is received. The operations may further include generating the interactive display including at least a graphical representation of the event sequence. The graphical representation of the event sequence may include one or more real-time event elements, and one or more interactive elements. The interactive display may be formatted in real time as the plurality of real-time event data is received. The one or more interactive elements may be configured to cause the interactive display to update the one or more real-time event elements in response to one or more user interactions. The operations may further include transmitting, to a user interface, the interactive display.

In a further aspect, an exemplary embodiment of a non-transitory computer-readable medium storing instructions that, when executed by one or more processors, perform operations. The operations may include receiving a plurality of real-time event data comprising a plurality of real-time event actions associated with a game identifier. The operations may further include generating an event sequence based on the plurality of real-time event actions. The event sequence may be generated in real-time as the plurality of real-time event data is received. The operations may further include generating the interactive display including at least a graphical representation of the event sequence. The graphical representation of the event sequence may include one or more real-time event elements, and one or more interactive elements. The interactive display may be formatted in real time as the plurality of real-time event data is received. The one or more interactive elements may be configured to cause the interactive display to update the one or more real-time event elements in response to one or more user interactions. The operations may further include transmitting, to a user interface, the interactive display.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 depicts an exemplary environment for generating an interactive display, according to one or more embodiments.

FIGS. 3A-3E depict an exemplary graphical user interface incorporating the interactive display for a soccer match, according to one or more embodiments.

FIGS. 4A-4G depict an exemplary graphical user interface incorporating the interactive display for a football game, according to one or more embodiments.

FIGS. 5A-5E depict an exemplary graphical user interface incorporating the interactive display for a basketball game, according to one or more embodiments.

FIG. 6 depicts a flowchart of an exemplary method for generating an interactive display, according to one or more embodiments.

FIG. 7 depicts an exemplary data flow diagram for generating an interactive display, according to one or more embodiments.

FIG. 8 depicts a flow diagram for training a machine-learning model, according to one or more embodiments.

FIG. 9 depicts an example of a computing device, according to one or more embodiments.

FIG. 10A is a block diagram illustrating a computing device, according to example embodiments.

FIG. 10B is a block diagram illustrating a computing device, according to example embodiments.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION OF ASPECTS

Various aspects of the present disclosure relate generally to computer-

implemented techniques for generating an interactive display including real-time event elements. The interactive display may allow a user to filter team and player data based on real-time game events. The interactive display may provide a visual timeline of a sporting event (e.g., soccer match), and may therefore allow a user to make informed decisions using real-time game events, being guided by data visualization, filtering of real-time game events, and the like. One or more interactive elements may allow a user to visually filter real-time game events, thereby generating a substantially new interactive display based on the user interactions.

Additionally, shifts in the momentum (e.g., game events) of a game may be measured by filtering the real-time game events as they occur in real-time game play. In examples, momentum may measure shifts in a game (e.g., game events associated with a team are becoming more threatening to the opposing team at a particular point(s) in time. Momentum, therefore, may measure the likelihood of the team (e.g., associated with the game events) scoring one or more points in a predetermined amount of time. In various embodiments, momentum may be derived from a possession value, which may measure the impact that each individual game event may have on changing the probability of a team scoring the one or more points within the predetermined amount of time. Therefore, users may further be guided by the data visualization to make informed decisions using the game-based data.

In an exemplary use case, a soccer match may be visualized and filtered using multiple (e.g., three) mechanisms. First, the real-time game events may be filtered by pre-determined time frames (e.g., first half, second half, extra time, or the like). Second, the real-time game events may be filtered by event time. In examples, the real-time event data may be filtered according to each individual event or collection of events (e.g., goal scored, pass completed, or the like). Third, the real-time game events may be filtered by visual timeline. In examples, a visual timeline for a soccer match may allow a user to view game activity in different modes: events, momentum, and chances. In the events mode, a plurality of unique soccer events may be mapped onto the visual timeline. In the momentum mode, a visual representation of the likelihood of a team to score may be represented in an interactive display. In the chances mode, values determined using data related to players and the like may be mapped onto the visual timeline or interactive display. In various embodiments, real-time tabular data may be represented in the interactive display. In examples, as the user interacts with the interactive display, the tabular data may update to reflect the selections made by the user. Such selections may include team statistics, player statistics, and player statistics separated by player position.

In another exemplary use case, a basketball game may be visualized and filtered using multiple (e.g., four) mechanisms. First, the real-time game events may be filtered by pre-determined time frames (e.g., full game, first half, second half, first quarter, second quarter, and the like). Second, the real-time game events may be filtered by runs. In examples, such runs may be unanswered points, or period of time when a team is outscoring another team. Such runs may be highlighted in the visual timeline, or represented as an interactive element in the interactive display. Third, the real-time game events may be filtered by event time. In examples, the real-time game events may be filtered by rebounds, missed shots, substitutions, turnovers, fouls, and the like. Fourth, the real-time game events may be filtered by visual timeline. In examples, an events mode and a lead tracker may be separate data visualizations that inform a user when there is a high level of activity during a game. In various embodiments, real-time tabular data may be represented in the interactive display. In examples, as the user interacts with the interactive display, the tabular data may update to reflect the selections made by the user. Such selections may include team statistics, player statistics, shot assist matrix, shot streaks, and player comparison data.

In another exemplary use case, a football game may be visualized and filtered using multiple (e.g., four) mechanisms. First, the real-time game events may be filtered by pre-determined time frames (e.g., full game, first half, second half, first quarter, second quarter, and the like). Second, the real-time game events may be filtered by event time, such as a first and ten, and the like. Third, the real-time game events may be filtered by drives. In examples, user may group drives by scoring or non-scoring drives, or by user-selected drive groupings. Fourth, the real-time game events may be filtered by visual timeline. In examples, the visual timeline may be generated based on a designation on whether or not the team scored, or using a win probability. In various embodiments, real-time tabular data may be represented in the interactive display. In examples, as the user interacts with the interactive display, the tabular data may update to reflect the selections made by the user. Such selections may include team statistics, player statistics, and team efficiency data.

In various embodiments, the interactive display may include a zoom control that allows a user to interact with the visual timeline. A user may thereby zoom in or out on one or more data points, allowing precise slicing of the data to view granularity of the time markers of certain real-time game events by increasing the space between real-time game events in a visually interactive manner.

Further, the generated data, such as the interactive elements and interactive display, may be used as input into a machine-learning or artificial intelligence model. In examples, a user may be able to interact with a language learning model (LLM) that is trained to output responses to user questions or user interactions, using the generated data. In this way, a user may interact with real-time game event data and live output (e.g., the generated interactive display).

Therefore, the present disclosure also provides for machine-learning and based techniques of performance prediction. Additionally, using artificial-intelligence based techniques for natural language processing may allow for user interaction with the data. The logistical and financial challenges and/or undesired results associated with determining odds for anticipated player performance may be also be reduced. More specifically, techniques disclosed herein to generate displayed statistics for each player or team may provide for faster, real-time, more accurate, more efficient, and tailored processing of game event data in comparison to conventional techniques. Techniques disclosed herein further reduce the computational resources required for such processing by, for example, leveraging machine learning training to reduce just-in-time processing loads.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

As discussed herein, one or more machine learning models may be trained to understand a sports language. Accordingly, machine learning models disclosed herein are sports machine learning models. Such sports machine learning models may be trained using sports related data (e.g., tracking data, event data, etc., as discussed herein). A sports machine learning model trained to understand a sports language based on sports related data may be trained to adjust one or more weights, layers, nodes, biases, and/or synapses based on the sports related data. A sports machine learning model may include components (e.g., weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine learning model may correlate sports information and statistics in a competition landscape. A sports machine learning model may be trained to adjust one or more weights, layers, nodes, biases, and/or synapses to associate certain sports statistics in view of a competition landscape. For example, a win indicator for a given team may be automatically correlated with a loss indicator for an opposing team. As another example, a score statistic may be considered a positive attribution for a scoring team and a negative attribution for a team being scored upon. As another example, a given score may be ranked against one or more scores based on a relative position of the score in comparison to the one or more other scores.

A sports machine learning model may be trained based on sports tracking and/or event data, as discussed herein. Such data may include player and/or object position information, movement information, trends, and/or changes. For example, a sports machine learning model may be trained by modifying one or more weights, layers, nodes, biases, and/or synapses to associate given positions in reference to the playing surface of venue and/or in reference to one or more agents. As another example, a sports machine learning model may be trained by modifying one or more weights, layers, nodes, biases, and/or synapses to associate given movement or trends in reference to the playing surface of venue and/or in reference to none or more agents. As another example, a sports machine learning model may be trained by modifying one or more weights, layers, nodes, biases, and/or synapses to associate sporting events with corresponding time boundaries, teams, players, coaches, officials, and environmental data associated with a location of corresponding sporting events.

A sports machine learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine learning model may be trained in viewing sports targets, play outcomes, player positions, and/or the like associated with a given sport (e.g., soccer, American football, basketball, baseball, tennis, golf, rugby, hockey, a team sport, an individual sport, etc.). For example, a soccer based sports machine learning model may be trained to correlate or otherwise associate player position information in reference to a soccer pitch. The soccer based sports machine learning model may further be trained to correlate or otherwise associate sports data in reference to a number of players and sports targets specific to soccer.

According to aspects, one or more given sports machine learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine learning model may receive inputs including sports data for a given sport and may generate a matrix representation based on features of the given sport. The sports machine learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine learning model may perform operations based on the generated matrix. The features may be updated based on input data or updated training data based on, for example, sports data associated with features that the model is not previously trained to associate with the given sport. Accordingly, sports machine learning models may be iteratively trained based on sports data or simulated data.

The execution of the machine-learning model may include deployment of one or more machine-learning techniques, such as a transformer model, graph neural network (GNN), linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine-learning and artificial intelligence, it should be understood that techniques according to this disclosure may be adapted to any suitable type of machine-learning and/or artificial intelligence. It should also be understood that the examples above are illustrative only. The techniques and technologies of this disclosure may be adapted to any suitable activity.

While sporting events and various aspects relating to sporting events (e.g., game events during a sporting event) are described in the present aspects as illustrative examples, the present aspects are not limited to such examples. For example, the present aspects can be implemented for other types of events or actions, such as, for example, financial activities, activities involving strategy and prediction of actions to be taken, or other implementations where the performance of an individual, collection of individuals, or objects is assessed or predicted.

While sporting event and various aspects relating to sporting events may be described in relation to a given sport, it will be understood that such aspects may be implemented for any applicable sport such as, but not limited to, team sports, individual sports, soccer, basketball, American football, rugby, golf, tennis, hockey, cricket and/or the like.

According to embodiments disclosed herein, a transformer neural network may receive inputs (e.g., tensor layers), where each input corresponds to a given player, team, or game. The transformer neural network may output generated predictions for one or more given players or teams based on such inputs. More specifically, the transformer neural network may output such generated predictions for a given player or team based on inputs associated with that given player or team and further based on the influence of one or more other players or teams. Accordingly, predictions provided by a transformer neural network, as discussed herein, may account for the influence of multiple players and/or teams when outputting a prediction for a given player and/or team.

The system described herein may include a machine learning system configured to generate one or more predictions. In some examples, the system may incorporate a transformer neural network, graphical neural network, a recurrent neural network, a convolutional neural network, and/or a feed forward neural network. The system may implement a series of neural network instances (e.g., feed forward network (FFN) models) connected via a transformer neural network (e.g., a graph neural network (GNN) model). Although a transformer neural network is generally discussed herein, it will be understood that any applicable GNN, or other neural network that may utilize graphical interpretations, may be used to perform the techniques discussed herein in reference to a transformer neural network.

The transformer-based neural network may include a set of linear embedding layers, a transformer encoder, and a set of fully connected layers. The set of linear embedding layers may map component tensors of received inputs into tensors with a common feature dimension. The transformer encoder may perform attention along the temporal and agent dimensions. The set of fully connected layers may map the output embeddings from a last transformer layer of the transformer encoder into tensors with requested feature dimension of each target metric.

The transformer-based neural network may be configured to receive input features through the set of linear embedding layers. The input features may be received at different resolutions and over a time-series. The input features may relate to player features, team features, and/or game features. Input features may be input into the linear embedding layers as a tuple of input tensors. For example, a tuple of three tensors may be provided where the first tensor corresponds to all players in a match, a second tensor corresponds to both teams in the match, and the third tensor corresponds to a match state.

Examining the set of linear embedding layers, the linear embedding layers may contain a linear block for each input tensor of the tuple, and each block may map an input tensor to a tensor with a common feature dimension D. The output of the linear embedding layer may be a tuple of tensors, with a common feature dimension, which can be concatenated along the temporal and agent dimension to form a single tensor.

The transformer encoder may be configured to receive the single tensor from the linear embedding layers. The transformer encoder may be configured to learn an embedding that is configured to generate predictions on multiple actions for each agent (e.g., each player and/or team). The transformer encoder may include a series of axial transformer encoder layers, where each layer alternatively applies attention along the temporal and agent dimensions. The transformer encoder may include layers that alternate between temporally applying attention to sequences of action events, and applying attention spatially across the set of players and teams at each event time-step. The transformer encoder may include axial encoder layers configured to accept a tensor from the linear layers and apply attention along the temporal dimension, then along the agent dimension.

The attention mechanism that is implemented by the transformer encoder layers may have a graphical interpretation on a dense graph where each element is a node, and the attention mask is the inverse of the adjacency matrix defining the edges between the nodes (the absence of an attention mask thus implies a fully-connected graph). In the case of the axial attention used here, with the attention mask on the temporal (row) dimension, the nodes in the graph can be arranged in a grid, and each node may be connected to all nodes in the same column, and to all previous nodes in the same row. Attention, in this case, may be message-passing where each node can accept messages describing the state of the nodes in its neighborhood, and then update its own state based on these messages. This attention scheme may mean that when making a prediction for a particular player, the model may consider (i.e. attend to): the nodes containing the previous states of the player along the time-series; and the state nodes of the other players, team and the current game state in the current time-step. It may not be necessary for the nodes to be homogeneous-beyond having the same feature dimension-and thus a node that represents a player can accept messages from a node that represents at team, or from the player's strength node. The model may therefore learn the interactions between agents, and ensure consistent predictions for each agent along the time-series. The output of the transformer encoder layers may be a tensor (e.g., an output embedding).

The final layers of the transformer-based neural network may be the fully connected layers. These layers may map the output embedding of the final transformer layer of the transformer encoder to the feature dimension of each target metric. The final layers may output a target tuple that contains tensors for each of a set of modeled actions for each player and/or team. For example, the modeled action may be an empirical estimate of distributions for sport statistics such as number of shots taken, number of goals, number of passes, etc.

The training of the transformer-based neural network may include choosing a corresponding loss function for the distribution assumption of each output target. For example, the loss function may be the Poisson negative log-likelihood for a Poisson distribution, binary cross entropy for a Bernouilli distribution, etc. The losses may be computed during training according to the ground truth value for each target in the training set, and the loss values may be summed, and the model weights may be updated from the total loss using an optimizer. The learning rate may have been adjusted on a schedule with cosine annealing, without warm restarts.

As discussed above, the conventional user interfaces had many deficits relating to the efficient functioning of the computer, providing only limited options (e.g., filtering based on set time limits) for a user. Aspects of the present disclosure may address this issue in the conventional user interface by providing improved user interfaces that allow the user to more quickly access desired data processed/filtered/generated based on real-time or near real-time data, which are stored in an electronic system/device/application.

Aspects of the present disclosure may improve the efficiency of using the electronic system/device/application, for example, by providing various options to filter various sports data in real-time or near real-time and displaying selected data in one screen/window/view, allowing the user to see the most relevant data or functions without having to review all real-time data or separately calculate/process such data. Aspects of the present disclosure may also improve the speed of a user's navigation through relevant data, by allowing the user to focus on relevant data using various filtering options, thereby saving computer resources and increasing computer processing speed.

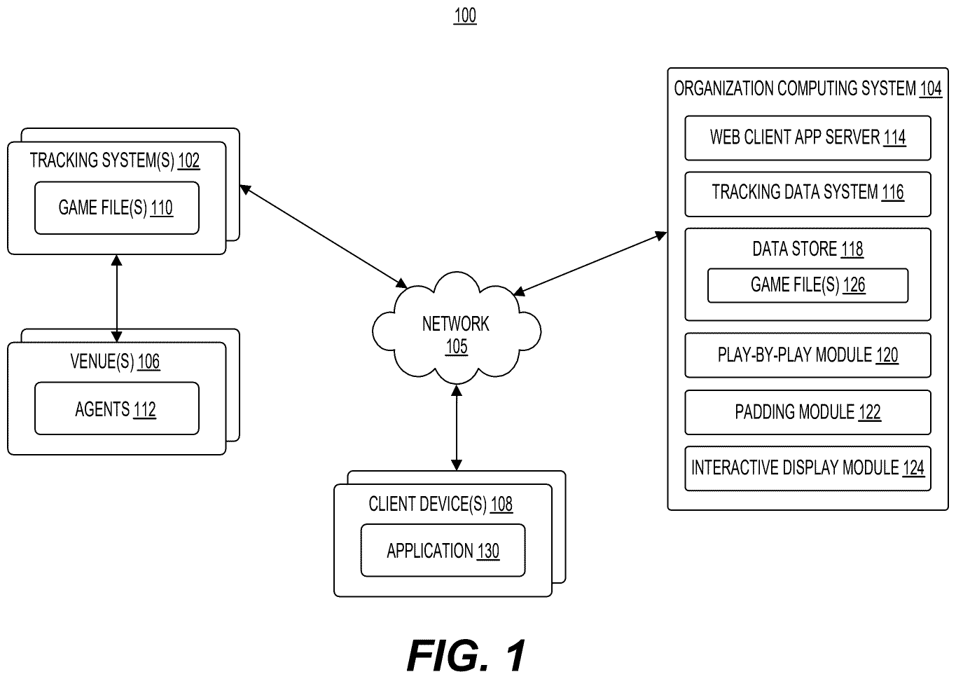

FIG. 1 is a block diagram illustrating a computing environment 100, according to example embodiments. Computing environment 100 may include tracking system 102 (e.g., positioned at or in communication with one or more components positioned at venue 106), organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106 and/or may be in communication (e.g., electronic communication, wireless communication, wired communication, etc.) with components located at venue 106. For example, venue 106 may be configured to host a sporting event that includes one or more agents 112. Tracking system 102 may be configured to capture the motions of one or more agents (e.g., players) on the playing surface, as well as one or more other agents (e.g., objects) of relevance (e.g., ball, puck, referees, etc.). In some embodiments, tracking system 102 may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system (e.g., tracking system 102) may result in many different camera views of the playing surface (e.g., high sideline view, free-throw line view, huddle view, face-off view, end zone view, etc.).

In some embodiments, tracking system 102 may be used for a broadcast feed of a given match. For example, tracking system 102 may be used to generate game files 110 to facilitate a broadcast feed of a given match. In such embodiments, each frame of the broadcast feed may be stored in a game file 110. A broadcast feed may be a feed that is formatted to be broadcast over one or more channels (e.g., broadcast channels, internet based channels, etc.). A game file 110 may be converted from a first format (e.g., a format output by the one or more cameras or a different format than the format output by the one or more cameras) and may be converted into a second format (e.g., for broadcast transmission).

In some embodiments, game file 110 may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data (e.g., from tracking system 102), and/or one or more other data types such as a video feed, excitement data, etc. The computing system may utilize a machine learning model to determine when given tracking data or changes in tracking data (e.g., given player movements, object movements, changes in the same, etc.) correspond to an event (e.g., a scoring event, a penalty event, a possession based event, play type event, etc.). Event data may be automatically identified using a machine learning trained to receive, as an input, a game file 110 or a subset thereof and output game information and/or context information based on the input. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine learning models. The one or more machine learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports events.

Tracking system 102 may be configured to communicate with organization computing system 104 via network 105. For example, tracking system 102 may be configured to provide organization computing system 104 with a broadcast stream of a game or event in real-time or near real-time via network 105. As an example, tracking system 102 may provide one or more game files 110 in a first format (e.g., corresponding to a format based on the components of tracking system 102). Alternatively, or in addition, tracking system 102 or organization computing system 104 may convert the broadcast stream (e.g., game files 110) into a second format, from the first format. The second format may be based on the organization computing system 104. For example, the second format may be a format associated with data store 118, discussed further herein.

Organization computing system 104 may be configured to process the broadcast stream of the game. Organization computing system 104 may include at least a web client application server 114, tracking data system 116, data store 118, play-by-play module 120, padding module 122, and/or interactive display module 124. Each of tracking data system 116, play-by-play module 120, padding module 122, and interactive display module 124 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather than as a result of the instructions.

Tracking data system 116 may be configured to receive broadcast data from tracking system 102 and generate tracking data from the broadcast data. In some embodiments, tracking data system 116 may apply an artificial intelligence and/or computer vision system configured to derive player-tracking data from broadcast video feeds.

To generate the tracking data from the broadcast data, tracking data system 116 may, for example, map pixels corresponding to each player and ball to dots and may transform the dots to a semantically meaningful event layer, which may be used to describe player attributes. For example, tracking data system 116 may be configured to ingest broadcast video received from tracking system 102. In some embodiments, tracking data system 116 may further categorize each frame of the broadcast video into trackable and non-trackable clips. In some embodiments, tracking data system 116 may further calibrate the moving camera based on the trackable and non-trackable clips. In some embodiments, tracking data system 116 may further detect players within each frame using skeleton tracking. In some embodiments, tracking data system 116 may further track and re-identify players over time. For example, tracking data system 116 may reidentify players who are not within a line of sight of a camera during a given frame. In some embodiments, tracking data system 116 may further detect and track an object across a plurality of frames. In some embodiments, tracking data system 116 may further utilize optical character recognition techniques. For example, tracking data system 116 may utilize optical character recognition techniques to extract score information and time remaining information from a digital scoreboard of each frame.

Such techniques assist in tracking data system 116 generating tracking data from the broadcast feed (e.g., broadcast video data). For example, tracking data system 116 may perform such processes to generate tracking data across thousands of possessions and/or broadcast frames. In addition to such process, organization computing system 104 may go beyond the generation of tracking data from broadcast video data. Instead, to provide descriptive analytics, as well as a useful feature representation for interactive display module 124, organization computing system 104 may be configured to map the tracking data to a semantic layer (e.g., events).

Tracking data system 116 may be implemented using a machine learning model. The machine learning model may be trained using supervised, semi-supervised, or unsupervised learning, in accordance with the techniques disclosed herein. The machine learning model may be trained by analyzing training data using one or more machine learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

Play-by-play module 120 may be configured to receive play-by-play data from one or more third party systems. For example, play-by-play module 120 may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, play-by-play module 120 may utilize machine learning outputs and/or manually annotated data that may reflect the referee's ultimate adjudication. Such data may be referred to as the play-by-play feed.

To help identify events within the generated tracking data, tracking data system 116 may merge or align the play-by-play data with the raw generated tracking data (which may include the game and time fields). Tracking data system 116 may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, tracking data system 116 may be configured to perform various operations on the aligned tracking system. For example, tracking data system 116 may use the play-by-play data to refine the player and ball positions and precise frame of the end of possession events (e.g., shot/rebound location). In some embodiments, tracking data system 116 may further be configured to detect events, automatically, from the tracking data. In some embodiments, tracking data system 116 may further be configured to enhance the events with contextual information.

For automatic event detection, tracking data system 116 may include a neural network system trained to detect/refine various events in a sequential manner. For example, tracking data system 116 may include an actor-action attention neural network system to detect/refine one or more of: shots, scores, points, rebounds, passes, dribbles, penalties, fouls, and/or possessions. Tracking data system 116 may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine learning classifier (e.g., random decision forest, SVM, logistic regression etc.).

While mapping the tracking data to events enables a player representation to be captured, to further build out the best possible player representation, tracking data system 116 may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, tracking data system 116 may use a measure referred to as an “influence score.” The influences score may capture the influence a player may have on each other player on an opposing team on a scale of 0-100.In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Padding module 122 may be configured to create new player representations using mean-regression to reduce random noise in the features. For example, one of the profound challenges of modeling using potentially only limited games (e.g., 20-30 games) of data per player may be the high variance of low frequency events seen in the tracking data. Therefore, padding module 122 may be configured to utilize a padding method, which may be a weighted average between the observed values and sample mean.

Accordingly, for each player, tracking data system 116, play-by-play module 120, and padding module 122 may work in conjunction to generate a raw data set and a padded data set for each player.

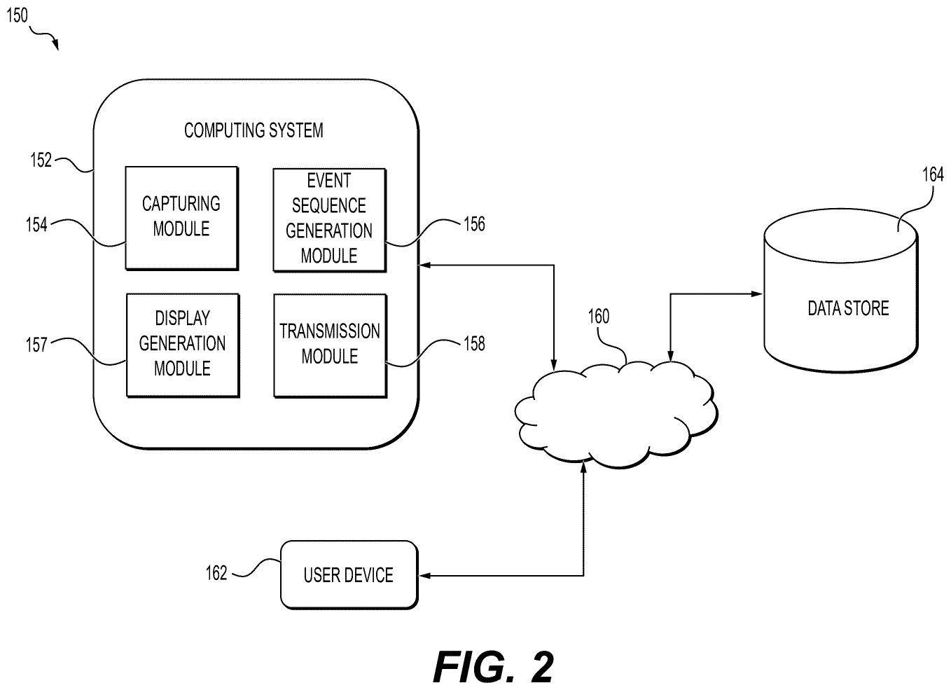

Interactive display module 124 may be configured or trained to generate an interactive display for an event sequence. Interactive display module 124 is discussed further in conjunction with FIG. 2 provided below.

Data store 118 may be configured to store one or more game files 126. Each game file 126 may include video data of a given match. For example, the video data may correspond to a plurality of video frames captured by tracking system 102, the tracking data derived from the broadcast video as generated by tracking data system 116, play-by-play data, enriched data, and/or padded training data. Game files 126 may be based, for example, on game files 110 as discussed herein. Game files 126 may be in a different format than game files 110. For example, a first format of game files 110 or a subset thereof may be transformed into a second format of game files 126. The transformation may be performed automatically based on the type and/or content of the first format and the type and/or content of the second format.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 130. Application 130 may be representative of a web browser that allows access to a website or a stand-alone application. Client device 108 may access application 130 to access one or more functionalities of organization computing system 104. Client device 108 may communicate over network 105 to request a webpage, for example, from web client application server 114 of organization computing system 104.The content that is displayed to client device 108 may be transmitted from web client application server 114 to client device 108, and subsequently processed by application 130 for display through a graphical user interface (GUI) of client device 108.

A prediction engine (e.g., which may be part of a tracking data system) may be configured to predict an underlying formation of a team. Mathematically, the goal of a role-alignment procedure may be to find the transformation A: {U₁, U₂, . . . , Uₙ}×M→[R₁, R₂, . . . , R_{K}], which may map the unstructured set U of N player trajectories to an ordered set (e.g., a vector) of K role-trajectories R. Each player trajectory itself may be an ordered set of positions Uₙ=[x_{s,n}]ₛ₌₁^{S} for an agent n∈[1, N] and a frame s∈[1, S]. In some embodiments, M may represent the optimal permutation matrix that enables such an ordering. The goal of the prediction engine may be to find the most probable set of [symbol] * of two-dimensional (2D) probability density functions:

$${ℱ}^{*} = arg {max}_{ℱ} P ( ℱ \vert R )$$

$$P ( x ) = {\sum }_{n = 1}^{N} P ( x \vert n ) P ( n ) = \frac{1}{N} {\sum }_{n = 1}^{N} {P}_{n} ( x )$$

In some embodiments, this equation may be transformed into one of entropy minimization where the goal is to reduce (e.g., minimize) the overlap (e.g., the KL-Divergence) between each role. As such, in some embodiments, the final optimization equation in terms of total entropy H may become:

$${ℱ}^{*} = arg {max}_{ℱ} {\sum }_{n = 1}^{N} H ( x \vert n )$$

The prediction engine may include a formation discovery module, a role assignment module, a template module, and/or the like each corresponding to a distinct phase of the prediction process. The formation discovery module may be configured to learn the distributions which maximize the likelihood of the data. The role assignment module may be configured to map each player position to a “role” distribution in each frame. Once the data has been aligned, the template module may be configured to map each learned formation a formation cluster template.

An organization computing system may receive tracking data and/or event data for a plurality of events across a plurality of seasons or across a match. For each event, the pre-processing agent may divide the event into a plurality of segments based on the event information. In some embodiments, the pre-processing agent may divide the event into a plurality of segments based on various events that may occur throughout the game. For example, the pre-processing agent may divide the event into a plurality of segments based on one or more events that include, but may not be limited to, red cards, ejections, technical fouls, flagrant fouls, player disqualifications, substitutions, halves, periods, quarters, overtime, and the like. Generally, each segment of a plurality of segments associated with an event may include an interval of a requisite duration (e.g., at least one minute of play, at least two minutes of play, etc.). Such requisite duration may allow an organization computing system to detect a team's formation.

Each segment may include a set of tracking data associated therewith. The player tracking data may be captured by tracking system, which may be configured to record the (x, y) positions of the players at a high frame rate (e.g., 10 Hz). In some embodiments, the player tracking data may further include single-frame event-labels (e.g., pass, shot, cross) in each frame of player tracking data. These frames may be referred to as “event frames.” As shown, the initial player tracking data may be represented as a set U of N player trajectories. Each player trajectory itself may be an ordered set of positions Uₙ=[x_{s,n}]ₛ₌₁^{S} for an agent n∈[1, N] and a frame s∈[1, S].

In some embodiments, the pre-processing agent may normalize the raw position data of the players. For example, the pre-processing agent may normalize the raw position data of the players in each segment so that all teams in the player tracking data are attacking from left to right and have zero mean in each frame. Such normalization may result in the removal of translational effects from the data. This may yield the set U′={U′₁, U′₂, . . . , U′ₙ}.

In some embodiments, the pre-processing agent may initialize cluster centers of the normalized data set for formation discovery with the average player positions. For example, average player positions may be represented by the set μ₀={μ₁, μ₂, . . . , μ₃}. The pre-processing agent may take the average position of each player in the normalized data and may initialize the normalized data based on the average player positions. Such initialization of the normalized data based on average player position may act as initial roles for each player to minimize data variance.

An organization computing system may learn a formation template from the tracking data for each segment. For example, the formation discovery module may learn the distributions which maximize the likelihood of the data. The formation discovery module may structure the initialized data into a single (SN)×d vector, where S may represent the total number of frames, N may represent the total number of agents (e.g., ten outfielders in the case of soccer, five players in the case of basketball, fifteen players in the case of rugby, etc.) and d may represent the dimensionality of the data (e.g., d=2).

The formation discovery module may then initiate a formation discovery algorithm. For example, the formation discovery module may initialize a K-means algorithm using the player average positions and execute to convergence. Executing the K-means algorithm to convergence produces better results than conventional approaches of running a fixed number of iterations.

The formation discovery module may then initialize a Gaussian Mixture Model (GMM) using cluster centers of the last iteration of the K-means algorithm. By parametrizing the distribution as a mixture of K Gaussians (with K being equal to the number of “roles,” which is usually also equal to N, the number of players), the formation discovery module may be able to identify an optimal formation that maximizes the likelihood of the data x. In other words, GMM may be configured to identify [symbol] *={P₁, P₂, . . . , P_{K}}, where [symbol] * may represent the optimal formation that maximizes the likelihood of the data x. Therefore, instead of stopping the process after the last iteration of the K-means algorithm, the formation discovery module may use GMM clustering, as the ellipse may better capture the shape of each player role compared to only a K-means clustering technique, which captures the spherical nature of each role's data cloud.

Further, GMMs are known to suffer from component collapse and become trapped in pathological solutions. Such collapse may result in non-sensible clustering, e.g., non-sensical outputs that may not be utilized. To combat this, the formation discovery module may be configured to monitor eigenvalues (λᵢ) of each of the components or parameters of the GMM throughout the expectation maximization process. If the formation discovery module determines that the eigenvalue ratio of any component becomes too large or too small, the next iteration may run a Soft K-Means (e.g., a mixture of Gaussians with spherical covariance) update instead of the full-covariance update. Such process may be performed to ensure that the eventual clustering output is sensible. For example, the formation discovery module may monitor how the parameters of the GMM are converging; if the parameters of the GMM are erratic (e.g., “out of control”), the formation discovery module may identify such erratic behavior and then slowly return the parameters back within the solution space using a soft K-means update.

For retrieval tasks using large amounts of data, an embodiment of the system uses a hash-table is required by grouping similar plays together, such that when a query is made, only the “most-likely” candidates are retrieved. Comparisons can then be made locally amongst the candidates and each play in these groups are ranked in order of most similar. Previous systems attempted clustering plays into similar groups by using only one attribute, such as the trajectory of the ball. However, the semantics of a play are more accurately captured by using additional information, such as information about the players (e.g., identity, trajectory, etc.) and events (pass, dribble, shot, etc.), as well as contextual information (e.g., if team is winning or losing, how much time remaining, etc.). Thus, embodiments of the present system utilize information regarding the trajectories of the ball and the players, as well as game events and contexts, to create a hash-table, effectively learning a “playbook” of representative plays for a team or player's behavior. The playbook is learned by choosing a classification metric that is indicative of interesting or discriminative plays. Suitable classification metrics may include predicting the probability of scoring in soccer or basketball (e.g., expected point value (“EPV”), or expected goal value (“EGV”). Other predicted values can also be chosen for performance variables, such as probability of making a pass, probability of shooting, probability of moving in a certain direction/trajectory, or the probability of fatigue/injury of a player.

The classification metric is used to learn a decision-tree, which is a coarse-to-fine hierarchical method, where at each node a question is posed which splits the data into groups. A benefit of this approach is that it can be interpretable and is multi-layered, which can act as “latent factors.”

In an embodiment of the system, a bottom-up approach to learning the decision tree is used. Various features are used in succession to discriminate between plays (e.g., first use the ball, then the player who is closest to the ball, then the defender etc.). By aligning the trajectories, there is a point of reference for trajectories relative to their current position. This permits more specific questions while remaining general (e.g., if a player is in the role of “point guard”, what is the distance from his/her teammate in the role of “shooting guard”, as well as the distance from the defender in the role of “point guard”). Using this approach avoids the need to exhaustively check all distances, which is enormous for both basketball and soccer.

In another embodiment of the system, a top-down approach to learning the decision tree is used. At a first step, all the plays are aligned to the set of templates. From this initial set of templates, the plays are assigned to a set of K groups (clusters), using all ball and player information, forming a Layer 1 of the decision tree. Back propagation is then used to prune out unimportant players and divide each cluster into sub-clusters (Layer 2). The approach continues until the leaves of the tree represent a dictionary of plays which are predictive of a particular task—e.g., goal-scoring (Layer 3).

In addition to raw trajectory information, in embodiments of the system, the plays in the database are also associated with game event information and context information. The game events and contexts in the database for a play may be inferred directly from the raw positional tracking data (e.g., a made or missed basket), or may be manually entered. Role information for players (can also be either inferred from the positional tracking data or entered separately. In embodiments of the system, a model for the database can then be trained by crafting features which encode game specific information based on the positional and game data and then calculating a prediction value (between 0 and 1) with respect to a classification metric (e.g., expected point value).

If there are a sufficient number of examples, the database model can be personalized for a particular player or game situation using those examples. In practice, however, a specific player or game situation may not be adequately represented by plays in the database. Thus, embodiments of the system find examples which are similar to the situation of interest—whether that be finding players who have similar characteristics or teams who play in a similar manner. A more general representation of a player and/or team is used, whereby instead of using the explicit team identity, each player or team is represented as a distribution of specific attributes. Embodiments of the system use the plays in the hash-table/playbook that were learned through the distributive clustering processes described above.

Further, while various aspects are discussed with respect to a single sport, such aspects are described are merely illustrative examples. Disclosed techniques are by no means limited to any sport in particular. For example, the present aspects can be implemented for other sports or activities, such as soccer, football, basketball, baseball, hockey, cricket, rugby, tennis, and so forth.

FIG. 2 depicts another exemplary environment 150 that may be utilized with techniques presented herein. One or more user device(s) 162 may communicate across an electronic network 160. The one or more user device(s) 162 may be associated with a user, e.g., a user that is viewing and/or interacting with a generated interactive display, an administrator of one or more components of environment 150, and/or the like.

As will be discussed in further detail below, one or more interactive display interactive display computing system(s) 152 may communicate with one or more of the other components of the environment 150 across electronic network 160.

The user device(s) 162 may be configured to enable a user to access and/or interact with other systems in the environment 150. For example, the user device(s) 162 may each be a computer system such as, for example, a desktop computer, a mobile device, a tablet, an augmented/virtual/extended reality device, and etc. In some embodiments, the user device(s) 162 may include one or more electronic application(s), e.g., a program, plugin, browser extension, etc., installed on a memory of the user device(s) 162. In some embodiments, the electronic application(s) may be associated with one or more of the other components in the environment 150. For example, the electronic application(s) may include one or more of system control software, system monitoring software, software development tools, etc. In some examples, the user device(s) 162 may be the same as or part of client device(s) 108.

In various embodiments, the environment 150 may include a data store 164 (e.g., database). The data store 164 may include a server system and/or a data storage system such as computer-readable memory such as a hard drive, flash drive, disk, etc. In some embodiments, the data store 164 includes and/or interacts with an application programming interface for exchanging data to other systems, e.g., one or more of the other components of the environment. The data store 164 may include and/or act as a repository or source for storing event data, event actions, a generated event sequence, output data, and the like (e.g., to be transmitted to user device 162 or any of the other components of environment 150). In some examples, the data store 164 may be the same as or part of the data store 118.

In some embodiments, the components of the environment 150 are associated with a common entity, e.g., a service provider, an account provider, or the like. For example, in some embodiments, interactive display interactive display computing system 152 and data store 164 may be associated with a common entity. In some embodiments, one or more of the components of the environment is associated with a different entity than another. For example, interactive display computing system 152 may be associated with a first entity (e.g., a service provider) while data store 164 may be associated with a second entity (e.g., a storage entity providing storage services to the first entity). The systems and devices of the environment 150 may communicate in any arrangement. As will be discussed herein, systems and/or devices of the environment 150 may communicate in order to one or more of generate, train, or use a machine-learning model to process natural language data, among other activities. In some examples, interactive display computing system 152 may be part of the organization computing system 104.

As discussed in further detail below, the interactive display computing system(s) 152 may, one or more of, (i) generate, store, train, communicate with, or use a machine-learning model configured to process natural language data. The interactive display computing system(s) 152 may include a machine-learning model and/or instructions associated with the machine-learning model, e.g., instructions for generating a machine-learning model, training the machine-learning model, using the machine-learning model etc. The interactive display computing system(s) 152 may include instructions for retrieving data, adjusting data, e.g., based on the output of the machine-learning model, and/or operating a display of the user device(s) 162 to output generated responses to user input, e.g., as adjusted based on the machine-learning model. The interactive display computing system(s) 152 may include training data, e.g., language data, and may include ground truth, e.g., (i) training language data and (ii) training player performance data to generate natural language responses.

As depicted in FIG. 2, interactive display computing system(s) 152 may include capturing module 154. In various embodiments, capturing module 154 is configured to receive a plurality of real-time event data. The real-time event data may be gathered and/or compiled by the interactive display computing system 152 or using components separate from environment 150. The plurality of real-time event data may include a plurality of real-time event actions associated with a game identifier. In examples, the real-time event actions may include actions associated with one or more players, a team, or the like during a match/game that may be tabulated (e.g., a goal scored, a pass completed, or the like). In various implementations, the event data may be received by the capturing module 154 almost simultaneous to an event action occurring or, at least, substantially simultaneous to the event action taking place. The plurality of real-time event data may be received by interactive display computing system(s) 152 over network 160. Further, one or more event actions associated with a unique game identifier may be updated (e.g., by capturing module 154 or interactive display computing system 152) with the plurality of real-time event actions. In some examples, the capturing module 154 may be part of the tracking data system 116 and/or interactive display module 124.

According to certain embodiments, capturing model 154 may receive in-venue or broadcast data associated with a sporting event. Such in-venue or broadcast data may be used to generate the event data discussed herein. For example, such in-venue or broadcast data may be provided to one or more event machine-learning models. The one or more event machine-learning models may be trained based on training data that includes historical or simulated in-venue or broadcast data, historical or simulated event data (e.g., tagged data), historical or simulated event actions (e.g., tagged data), and/or the like. The training data may be used to train the event machine-learning models by modifying one or more weighs, layers, synapses, biases, and/or the like of the event machine-learning models, in accordance with a machine-learning algorithm, as discussed herein. Alternatively, or in addition, such in-venue or broadcast data may supplement received event data for verification and/or use to generate an event sequence.

Interactive display computing system(s) 152 may also include event sequence generation module 156. In various embodiments, event sequence generation module 156 may be configured to generate an event sequence based on a plurality of real-time event actions. The event sequence may be generated in real-time as the plurality of real-time event data is received. In this way, the event sequence may be updated to reflect real-time event actions. In some examples, the event sequence generation module 156 may be part of the interactive display module 124.

As depicted in FIG. 2, interactive display computing system(s) 152 may also include display generation module 157. In various embodiments, display generation module 157 may be configured to generate an interactive display. The interactive display may include at least one of a graphical representation of the event sequence, including one or more real-time event elements, and one or more interactive elements. The interactive display may be formatted in real time as the plurality of real-time event data is received. In various embodiments, the one or more interactive elements may be configured to cause the interactive display to update the one or more real-time event elements in response to one or more user interactions. In some examples, the display generation module 157 may be part of the interactive display module 124.

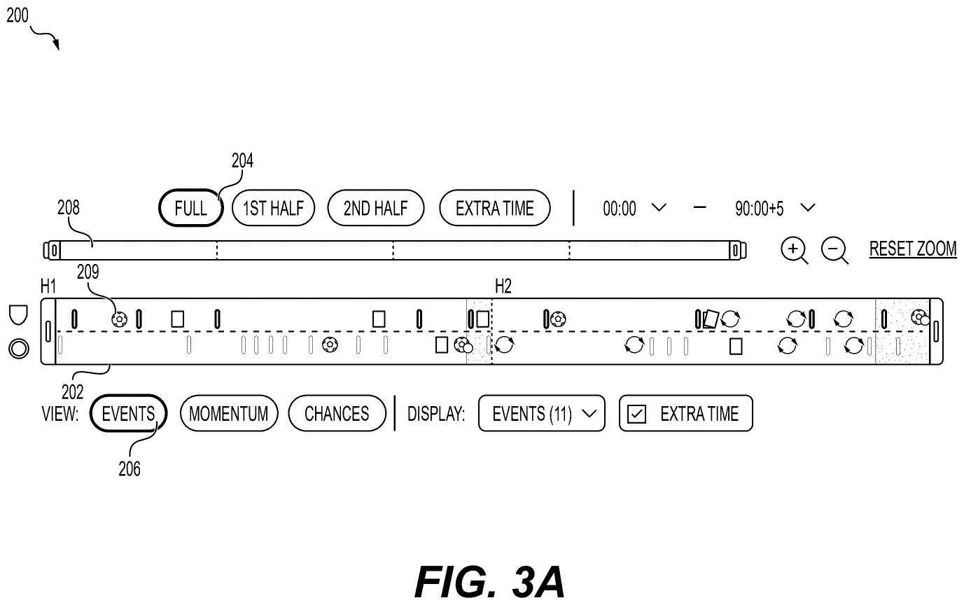

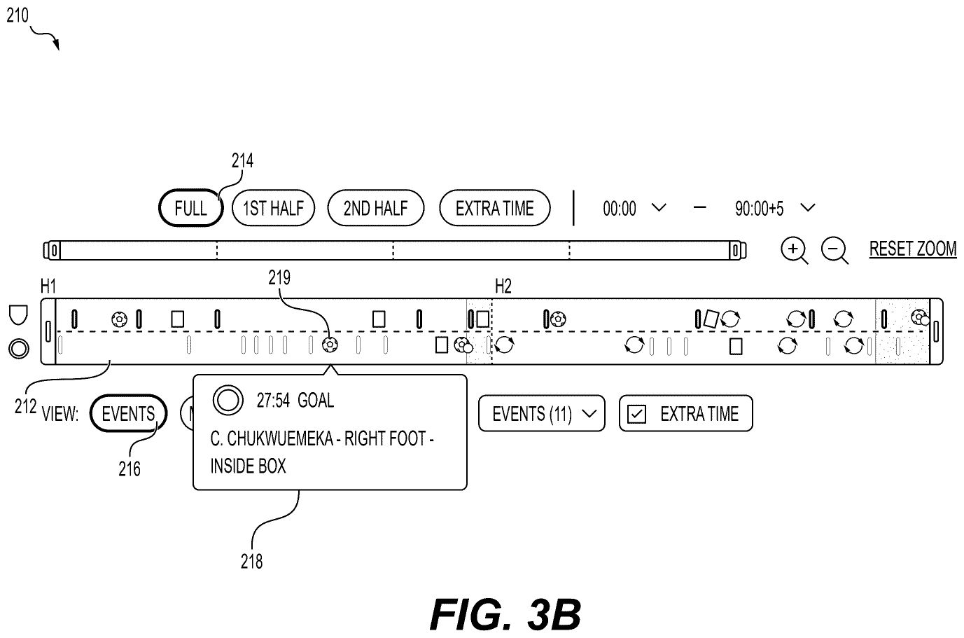

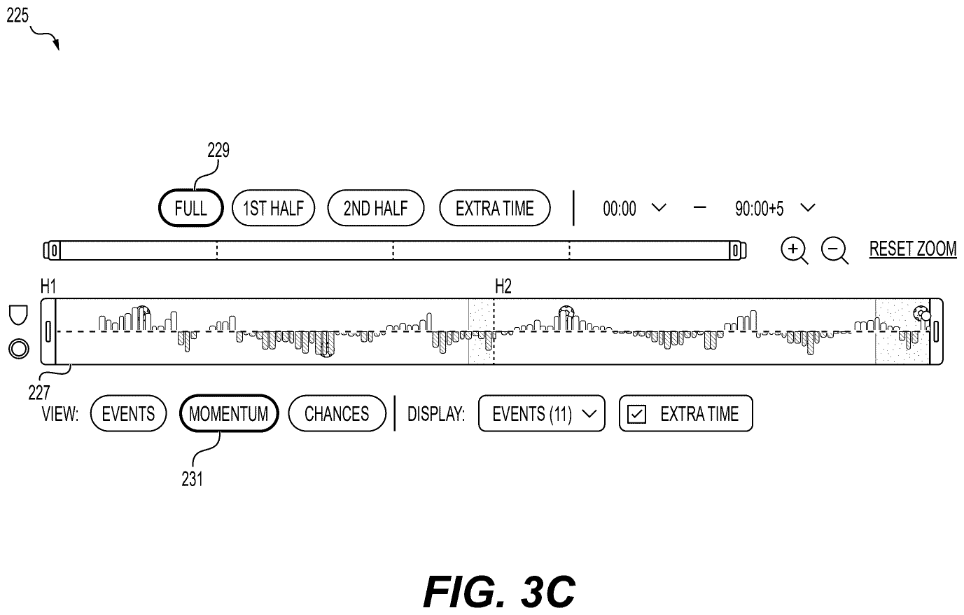

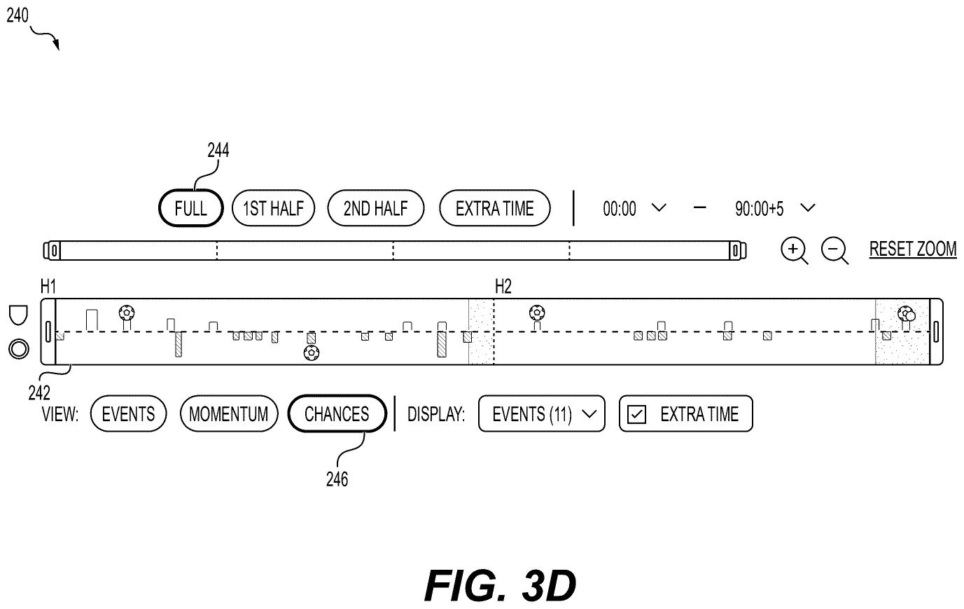

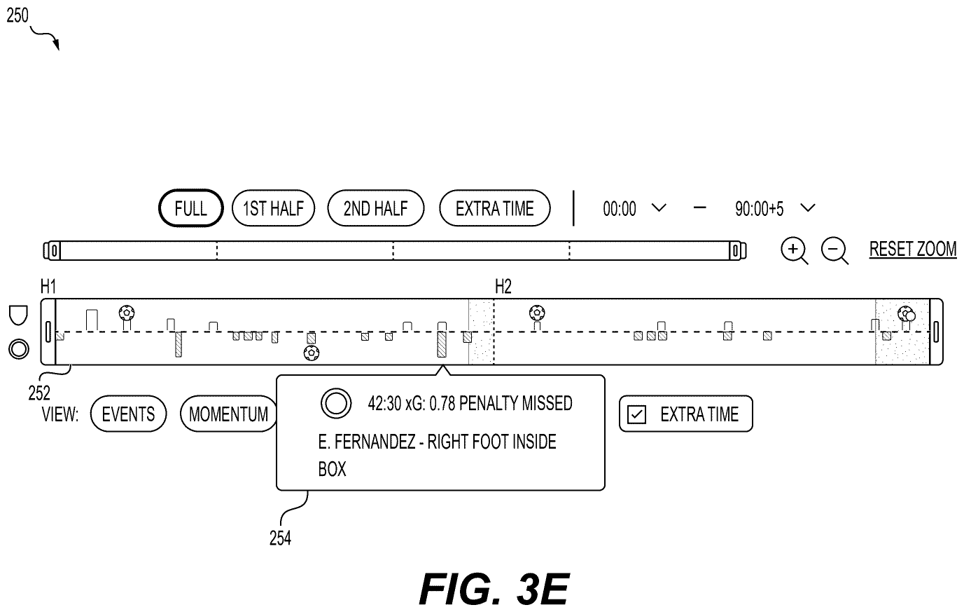

Exemplary embodiments of the interactive display will be described below in more detail with respect to FIGS. 3A-5E. In various embodiments, the interactive display is generated in real-time as the plurality of real-time event data is received (e.g., by capturing module 154). Interactive display computing system(s) 152 may also include transmission module 158. In various embodiment, transmission module 158 may be configured to transmit to a user interface the interactive display. In some examples, the transmission module 158 may be part of the interactive display module 124.

In various embodiments, the interactive display and/or a graphical representation of the event sequence and/or other items discussed herein may be displayed in real-time via applications (e.g., sports media applications, software applications, browser extensions, mobile applications, smart television applications, and the like), widgets (e.g., sports information cards, sports media stories, interactive elements within a software application, and the like), various graphics, and/or the like.

As depicted in FIG. 2, environment 150 may also include electronic network 160. In various embodiments, the electronic network 160 may be a wide area network (“WAN”), a local area network (“LAN”), personal area network (“PAN”), or the like. In some embodiments, electronic network 160 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like. In some examples, the electronic network 160 may be the same as or part of the network 105.

Although depicted as separate components in FIG. 2, it should be understood that a component or portion of a component in the environment 150 may, in some embodiments, be integrated with or incorporated into one or more other components. In another example, the interactive display computing system 152 may be integrated in a data storage system. The data storage system may be configured to communicate and/or receive/send data across electronic network 160 to other components of environment 150. In some embodiments, operations or aspects of one or more of the components discussed above may be distributed amongst one or more other components. Any suitable arrangement and/or integration of the various systems and devices of the environment 150 may be used.

Further aspects of the interactive display computing system 152 and how an interactive display is generated are discussed in further detail in the methods below. In the following methods and systems, various acts may be described as performed or executed by a component from FIG. 2, such as the interactive display computing system 152, the user device 162, or components thereof. However, it should be understood that in various embodiments, various components of the environment 150 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

FIGS. 3A-3E depict an exemplary graphical user interface incorporating the interactive display for a soccer match. As illustrated in FIG. 3A, an exemplary graphical user interface incorporates the interactive display 200. As described above, the interactive display 200 may be generated by a display generation module, such as that described with respect to FIG. 2 above. Interactive display 200 may be dynamically generated and updated in real time based on event data associate with a sporting event. The content provided via interactive display 200 may be ordered based on such sporting event data and may be filtered based on such sporting event data and/or user input. As illustrated in FIG. 3A, a graphical representation of an event sequence 202 may be included in the interactive display 200. The graphical representation of the event sequence 202 may include real-time event elements 209. In various implementations, the real-time event elements 209 may graphically represent real-time event actions (e.g., as received by capturing module 154, such as that described with respect to FIG. 2). As illustrated in FIG. 3A, a real-time event action, such as a goal scored, may be graphically represented as a soccer ball. In examples, other real-time event actions such as a completed pass, an interception, a goal conceded, or no action may be graphically represented as real-time event elements 209.

As illustrated in FIG. 3A, interactive elements 204, 206 may be configured to cause the interactive display 200 to update the one or more real-time event elements 209 in response to one or more user interactions (e.g., a mouse click or the like). As illustrated, the graphical representation of the event sequence 202 associated with a game identifier of a particular game (e.g., soccer match) may be filtered according to pre-determined time frames. As illustrated, upon a user interaction with a full game time frame button 204, the graphical representation of the event sequence 202 may be updated to display the event sequence of the full game associated with the game identifier. As illustrated, the graphical representation of the event sequence 202 may be filtered according to different modes of game activity, such as events, momentum, and chances. As illustrated, upon a user interaction with an events mode button 206, the real-time event actions, graphically represented as real-time event elements 209, may be mapped onto the graphical representation of the event sequence 202 according to that mode.

Additionally, as illustrated in FIG. 3A, the interactive display 200 may include a zoom control 208 that allows the user to interact with the graphical representation of the event sequence 202. A user may thereby zoom in or out on one or more real-time event elements 209, representing data points in the real-time event data (e.g., as received by capturing module 154, such as that described with respect to FIG. 2). The graphical representation of the event sequence 202 thereby updates to display precise slicing of the real-time event data, allowing the granularity of the time markers of certain real-time game events to be viewed within the interactive display 200 by increasing the graphically represented space between the real-time event elements 209 in a visually interactive manner.

As illustrated in FIG. 3B, a real-time event element data readout 218 may be generated in response to a user interaction. Upon a user interaction (e.g., a mouse click) with a real-time event element 219 graphically represented within the graphical representation of the event sequence 212, the data readout 218 may be generated and displayed within interactive display 210. Real-time event element data readout 218 may include a description of a sporting event corresponding to real-time event element 219. The description may be generated by inputting event data corresponding to real-time event element 219 into a sports large language model. The sports large language model may be trained to output the description based on sports related training, as discussed herein. As described above, with respect to FIG. 3A, a user interaction with a time frame button 214 and/or an events mode button 216, may cause the graphical representation of the event sequence 212 to update according to the user-selected filters.

As illustrated in FIG. 3C, one or more interactive elements 229, 231 of the interactive display 225 may cause the graphical representation of the event sequence 227 to update according to the respective filtering mechanisms. As illustrated, selecting a full game time frame button 229 and a momentum mode button 231 may cause the graphical representation of the event sequence 227 to update. Further, as illustrated in FIG. 3D, one or more interactive elements 244, 246 of the interactive display 240 may cause the graphical representation of the event sequence 242 to update according to the respective filtering mechanisms. As illustrated, selecting a full game time frame button 244 and a chances mode button 246 may cause the graphical representation of the event sequence 242 to update. In various embodiments, and as illustrated in FIG. 3E, a data readout 254 may be generated and displayed within interactive display 250 upon an interaction with one or more real-time event elements of the graphical representation of the event sequence 252. In various implementations, a data readout may be generated using data points of the received real-time event data, including real-time event actions. As illustrated, the data readout 254, may include a timestamp (e.g., an actual time in which the real-time event action took place, a time relative to other real-time event actions, or the like), a descriptive identifier of the real-time event action (e.g., “Penalty Missed”), and one or more textual elements to describe the real-time event action (e.g., a player's name and a textual description of the real-time event action, and the like). Such textual elements may be output by a sports large language model, as discussed herein.

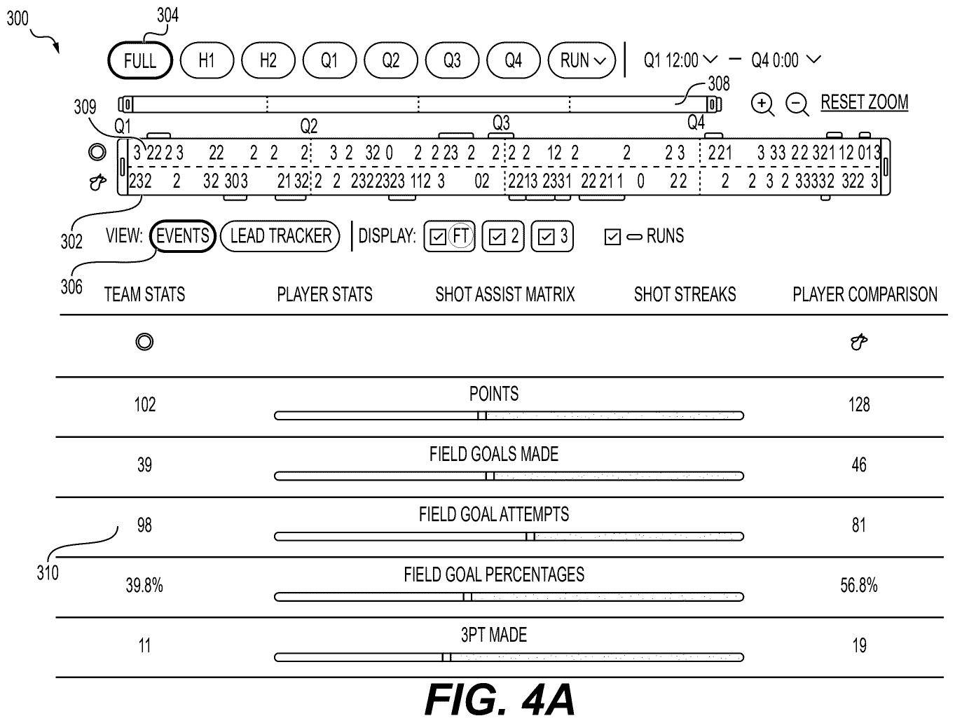

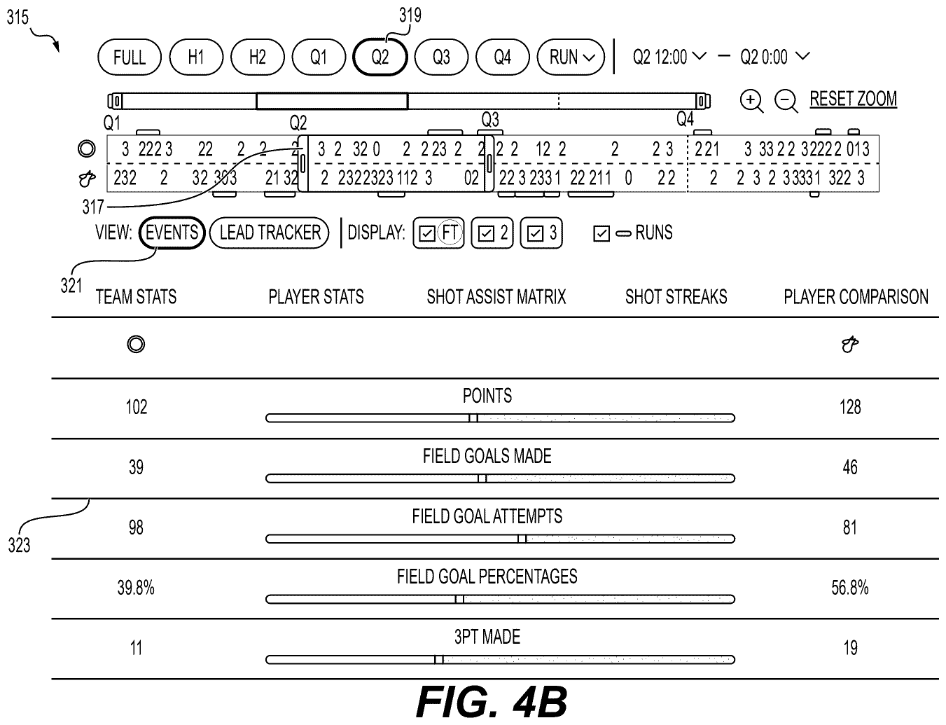

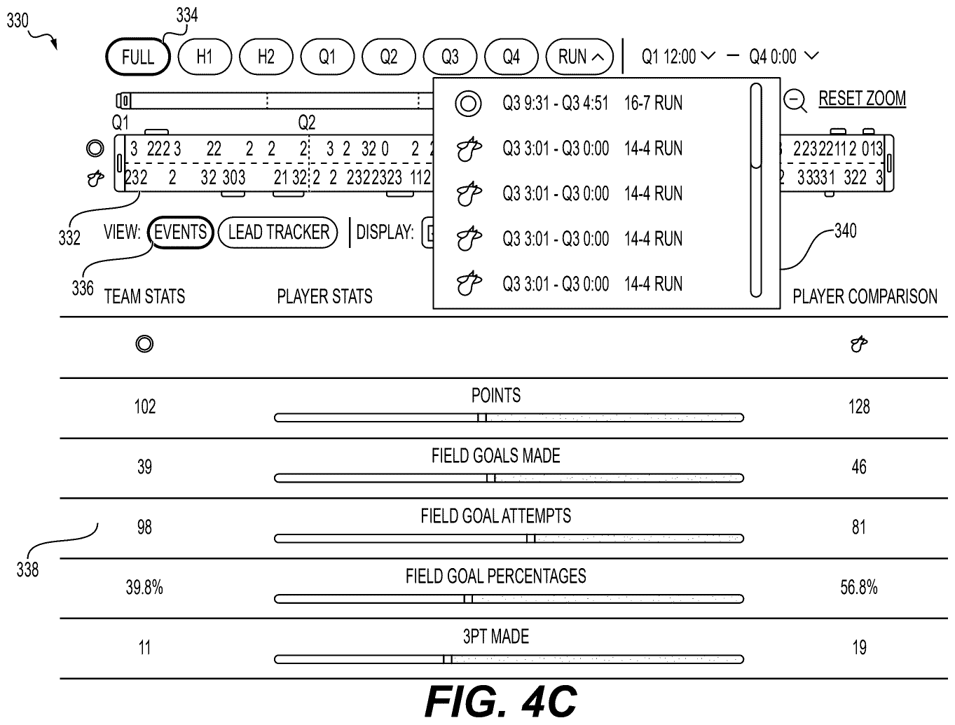

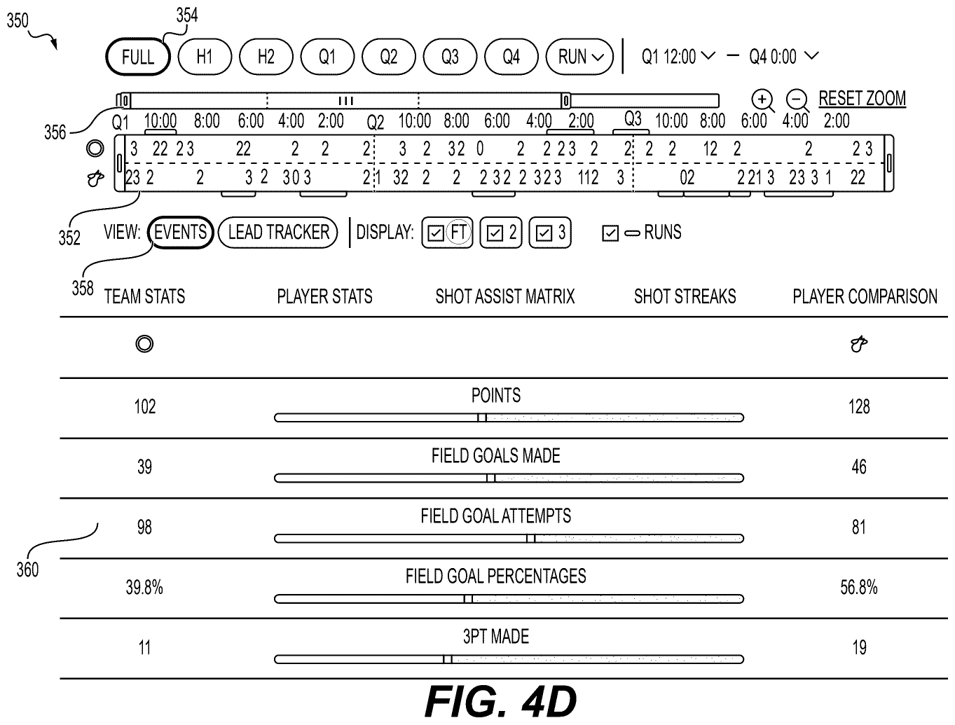

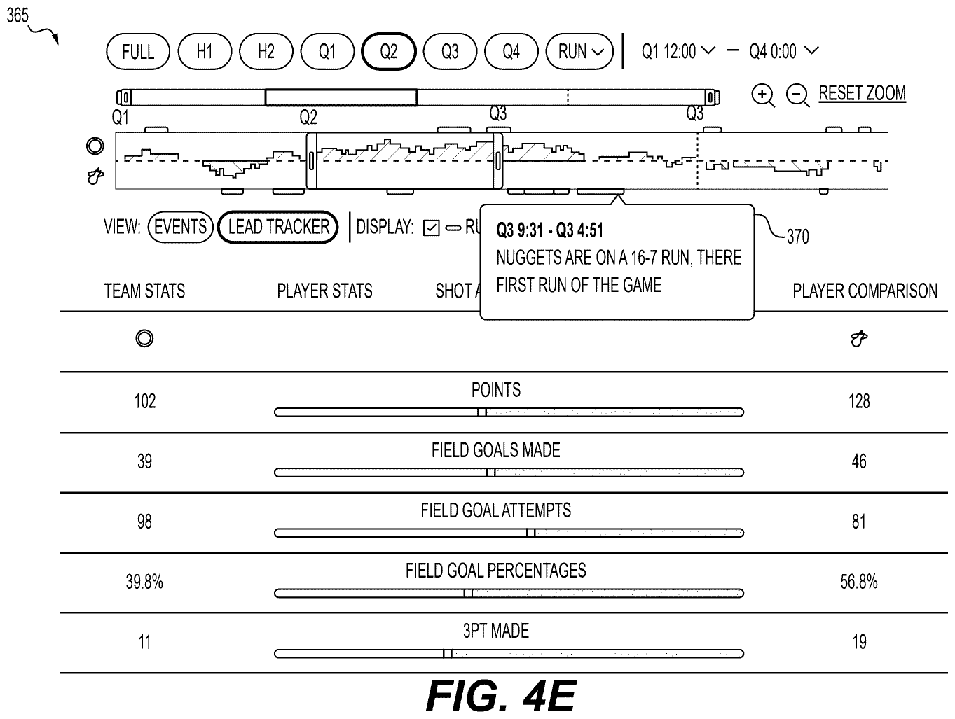

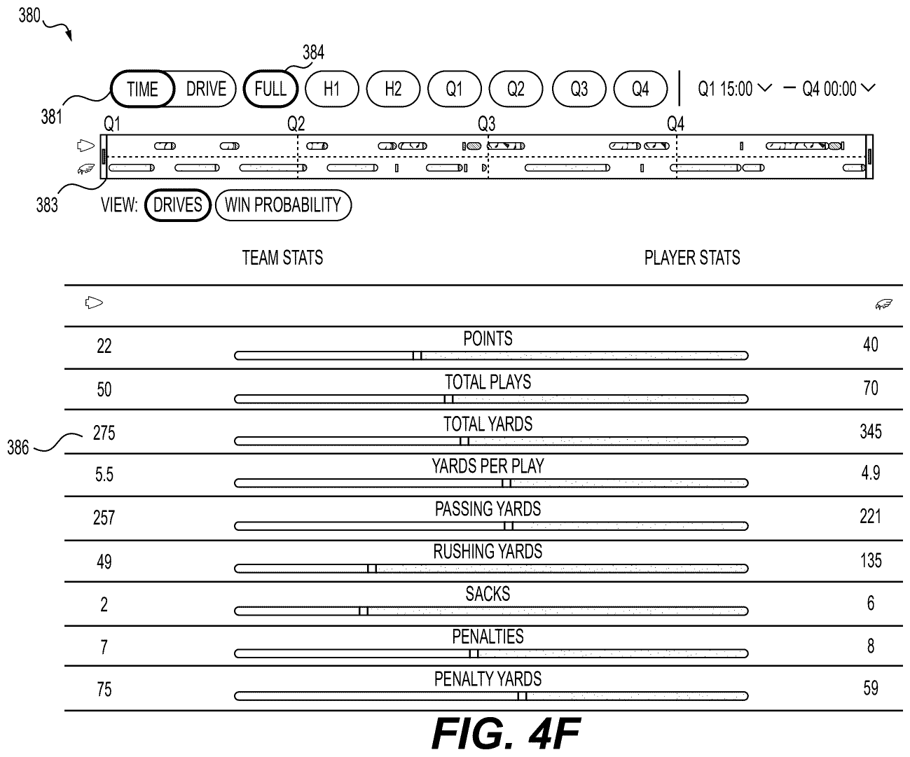

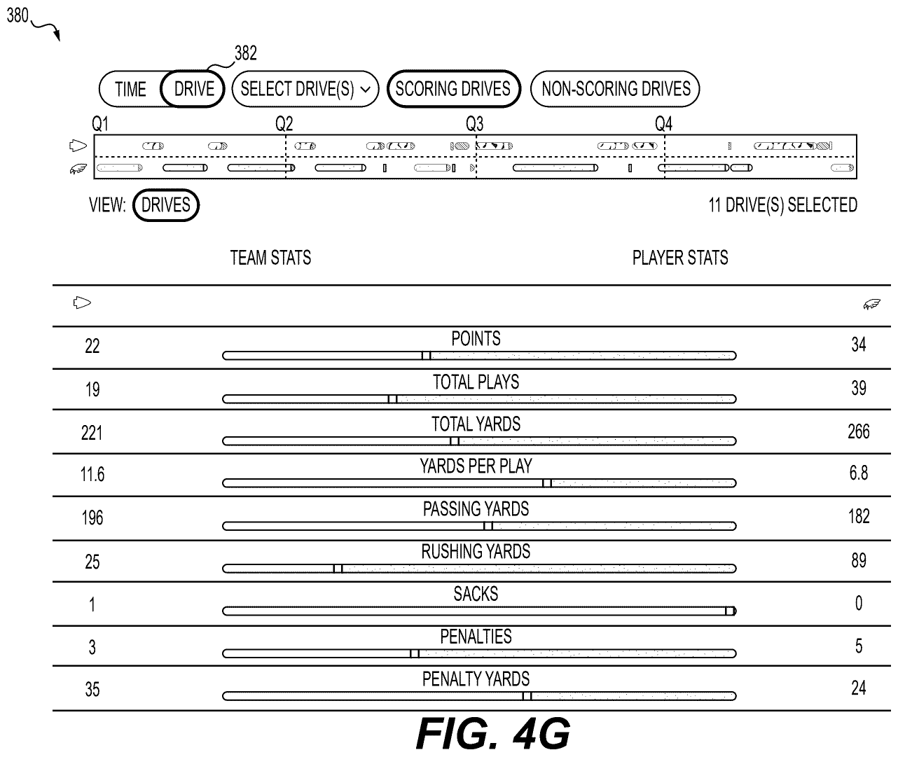

FIG. 4A-4E depict an exemplary graphical user interface incorporating the interactive display for a football game. As illustrated in FIG. 4A, an exemplary graphical user interface incorporates the interactive display 300. As described above, the interactive display 300 may be generated by a display generation module, such as that described with respect to FIG. 2 above. As illustrated in FIG. 4A, a graphical representation of an event sequence 302 may be included in the interactive display 300. The graphical representation of the event sequence 302 may include real-time event elements 309. In various implementations, the real-time event elements 309 may graphically represent real-time event actions (e.g., as received by capturing module 154, such as that described with respect to FIG. 2).

As illustrated in FIG. 4A, interactive elements 304, 306 may be configured to cause the interactive display 300 to update the one or more real-time event elements 309 in response to one or more user interactions (e.g., a mouse click or the like). As illustrated, the graphical representation of the event sequence 302 associated with a game identifier of a particular game (e.g., football game) may be filtered according to pre-determined time frames. As illustrated, upon a user interaction with a full game time frame button 304, the graphical representation of the event sequence 302 may be updated to display the event sequence of the full game associated with the game identifier. As illustrated, the graphical representation of the event sequence 302 may be filtered according to different modes of game activity, such as events and lead tracker. As illustrated, upon a user interaction with an events mode button 306, the real-time event actions, graphically represented as real-time event elements 309, may be mapped onto the graphical representation of the event sequence 302 according to the selected mode.

Additionally, as illustrated in FIG. 4A, the interactive display 300 may include a zoom control 308 that allows the user to interact with the graphical representation of the event sequence 302. A user may thereby zoom in or out on one or more real-time event elements 309, representing data points in the real-time event data (e.g., as received by capturing module 154, such as that described with respect to FIG. 2). The graphical representation of the event sequence 302 thereby updates to display precise slicing of the real-time event data, allowing the granularity of the time markers of certain real-time game events to be viewed within the interactive display 300 by increasing the graphically represented space between the real-time event elements 309 in a visually interactive manner.

As illustrated in FIG. 4A, interactive display 300 may include one or more graphical representations of game statistic tabs 310. As illustrated, a “Team Stats” tab, when selected by a user interaction, may display one or more graphical representations of the real-time event data. In examples, such graphical representations of the real-time event data may include a side-by-side comparison of team statistics such as points scored, field goals made, field goal attempts, and the like.

As illustrated in FIG. 4B, an event element slider 317 of the interactive display 315 may cause the graphical representation of the event sequence to update in response to one or more user interactions. Upon a user interaction (e.g., dragging the slider from one side of the graphical representation of the event sequence to another side) with the event element slider 317, the real-time event elements may be filtered, selected, displayed in an updated manner, or the like. In various implementations, selecting one or more real-time event elements by interacting with the event element slider 317 may cause a graphical representation of a game statistic tab 323 to update based on the selected event elements. For example, a graphical representation of points scored may update to include only those points scored included within the selected one or more real-time event elements.

As described above, with respect to FIG. 4A, a user interaction with a time frame button 319 and/or an events mode button 321, may cause the graphical representation of the event sequence to update according to the user-selected filters.

As illustrated in FIG. 4C, one or more interactive elements 334, 336 of the interactive display 330 may cause the graphical representation of the event sequence 332 to update according to the respective filtering mechanisms. As illustrated, selecting a full game time frame button 334 and an events mode button 336 may cause the graphical representation of the event sequence 332 to update. Additionally, the one or more interactive elements 334, 336 may cause a graphical representation of a game statistic tab 338 to update according to the respective filtering mechanisms. As illustrated in FIG. 4C, upon a user interaction with the graphical representation of the event sequence 332, a real-time event action readout 340 may populate with textual representations of data points included within the real-time event data and graphically represented by the one or more real-time event elements.

Further, as illustrated in FIG. 4D, one or more interactive elements 354, 358 of the interactive display 350 may cause the graphical representation of the event sequence 352 and/or one or more game statistics tabs 360 to update according to the respective filtering mechanisms. Additionally, as illustrated in FIG. 4D, the interactive display 350 may include a zoom control 356 that allows the user to interact with the graphical representation of the event sequence 352. A user may thereby zoom in or out on one or more real-time event elements, representing data points in the real-time event data (e.g., as received by capturing module 154, such as that described with respect to FIG. 2). The graphical representation of the event sequence 352 thereby updates to display precise slicing of the real-time event data, allowing the granularity of the time markers of certain real-time game events to be viewed within the interactive display 350 by increasing the graphically represented space between the real-time event elements in a visually interactive manner.

In various embodiments, and as illustrated in FIG. 3E, a graphical representation of a textual machine-learning output 370 may be displayed within the interactive display 365 based on a user interaction, a selection of one or more filters and/or interactive elements, in response to a selection of one or more real-time event elements, automatically based on the generation of the event sequence, or the like. In various implementations, a generative machine learning model trained to process natural language (e.g., a sports language learning model) may thereby process the real-time event data using natural language processing and data captured, generated, or stored, by the computing system (e.g., interactive display computing system 152 as depicted in FIG. 2), to generate a textual machine-learning output 370 that may be displayed in the interactive display 365. The textual machine-learning output 370 may be formatted in natural language that can be generally understood, and may utilized event data captured using interactive display computing system 152 or other components separate from environment 150 (as depicted in FIG. 2). In various embodiments, the textual machine-learning output 370 may be generated by a machine-learning model based on one or more predictions, conclusions, patterns, or the like identified or determined using the real-time event data.

A generative machine learning model may receive the real-time event data as an input. The generative machine learning model may be iteratively trained based training data such as the event data received at or generated by capturing module 154. Based on the training data, which may be updated in real time, the generative machine learning model may output a natural language output. The natural language output may be generated by, first, generating numerical values in response to the input and, second, converting the numerical values into the natural language output. Accordingly, the natural language model may be trained on sporting event data such that its output is specific to the sporting even data.

Generally, an artificial intelligence or machine-learning model disclosed herein includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between natural language data and real-time event data, such that the trained machine-learning model is configured to generate an output in response to receiving input.

In various embodiments, the variables of a machine-learning model may be interrelated in any suitable arrangement in order to generate the output. For example, in some embodiments, the machine-learning model may include natural language processing architecture that is configured to identify, isolate, and/or extract language features in input textual data. For example, the machine-learning model may include one or more convolutional neural network (“CNN”) configured to identify features in the text, and may include further architecture, e.g., a connected layer, neural network, etc., configured to determine a relationship between the identified features in order to determine and generate a natural language response that addresses the input, interaction, or the like.

In some embodiments, the machine-learning or artificial intelligence model may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive text as input, and generate an output in real-time. In some embodiments, the machine-learning model may include a transformer model and/or graph neural network (GNN) model. Such models may be configured to generate an output from input data.

As illustrated in FIGS. 4F-G, an exemplary graphical user interface incorporates the interactive display 380. As described above, the interactive display 380 may be generated by a display generation module, such as that described with respect to FIG. 2 above. As illustrated in FIGS. 4F-G, a graphical representation of an event sequence 383 may be included in the interactive display 380. The graphical representation of the event sequence 383 may include real-time event elements. In various implementations, the real-time event elements may graphically represent real-time event actions (e.g., as received by capturing module 154, such as that described with respect to FIG. 2).

As illustrated in FIGS. 4F-G, interactive elements 381, 382, 384 may be configured to cause the interactive display 380 to update the one or more real-time event elements in response to one or more user interactions (e.g., a mouse click or the like). As illustrated, the graphical representation of the event sequence 383 associated with a game identifier of a particular game (e.g., football game) may be filtered according to pre-determined time frames.

As illustrated in FIG. 4F, upon a user interaction with a time button 381 and a full game time frame button 384, the graphical representation of the event sequence 383 may be updated to display the event sequence of the full game associated with the game identifier. As illustrated in FIG. 4G, upon a user interaction with a drive button, the graphical representation of the event sequence 383 may be updated to display the event sequence related to scoring/non-scoring drives. The real-time game events may be filtered by using the drive button. In examples, user may group drives by scoring or non-scoring drives, or by user-selected drive groupings.

As illustrated in FIGS. 4F-G, interactive display 380 may include one or more graphical representations of game statistic tabs 386. As illustrated, a “Team Stats” tab, when selected by a user interaction, may display one or more graphical representations of the real-time event data. In examples, such graphical representations of the real-time event data may include a side-by-side comparison of team statistics such as points scored, total plays, total yards, yards per play, passing yards, rushing yards, sacks, penalties, penalty yards, and the like.

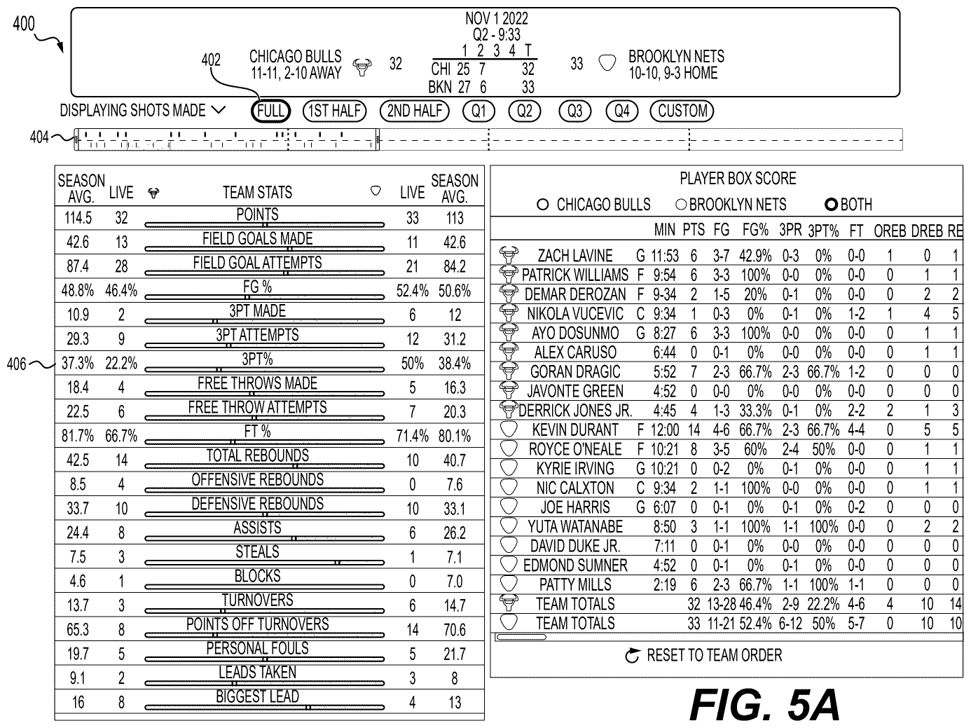

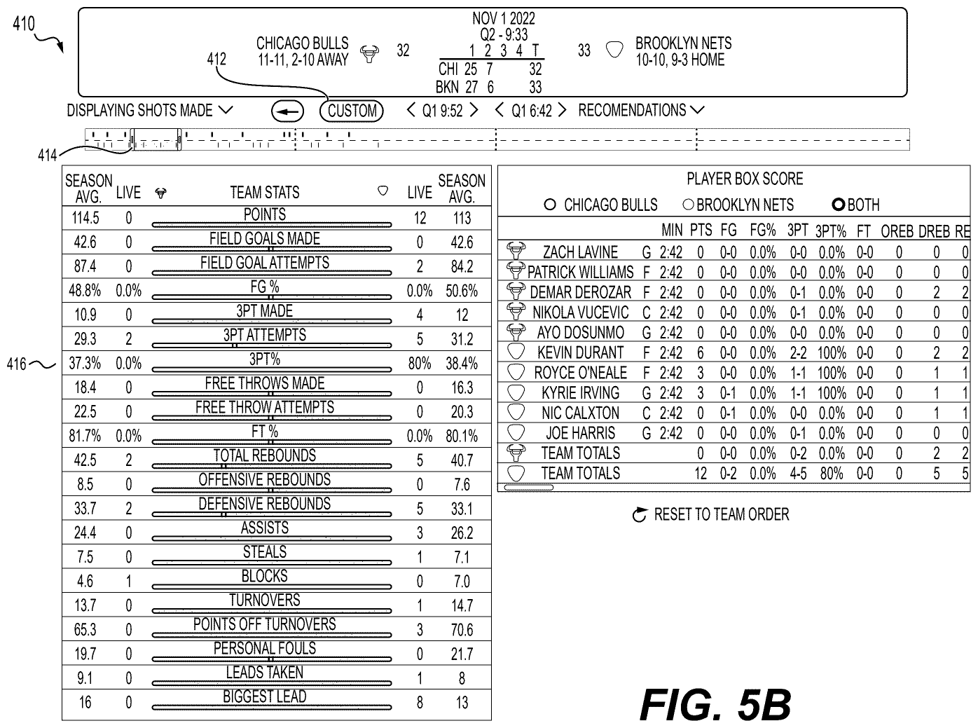

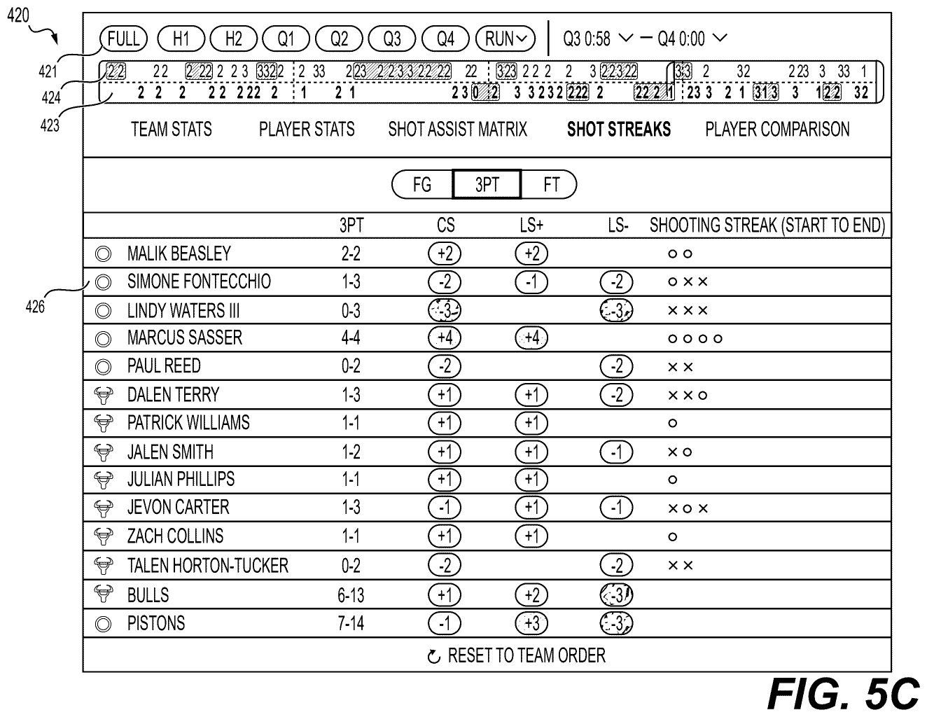

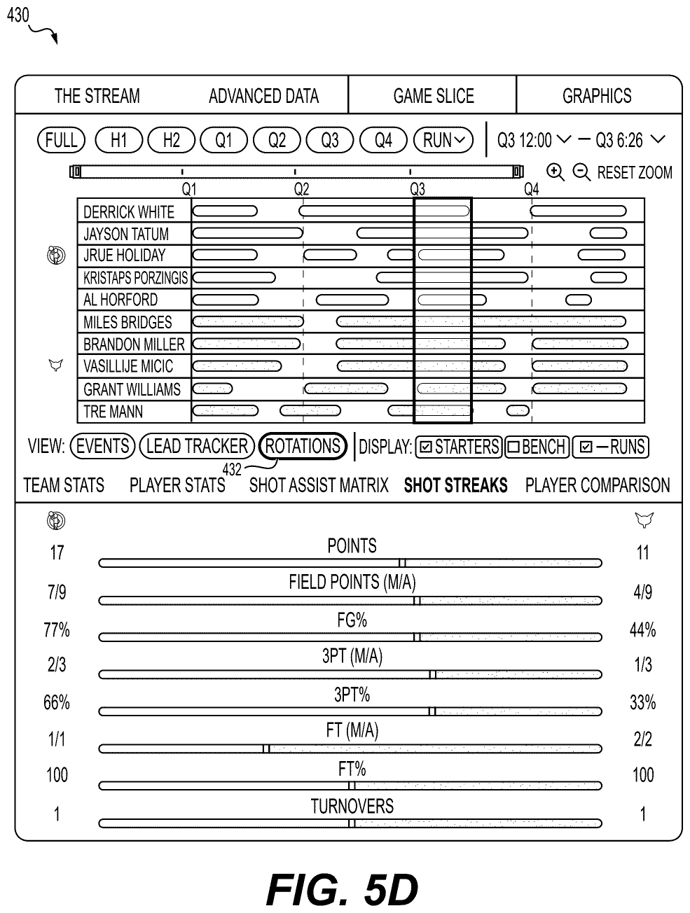

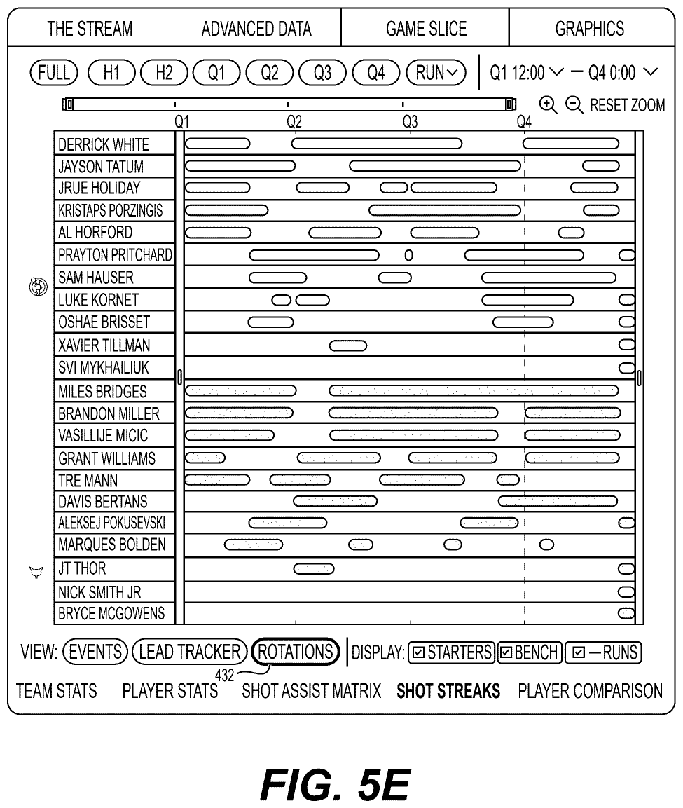

FIGS. 5A-5E depict an exemplary graphical user interface incorporating the interactive display for a basketball game. As illustrated in FIG. 5A, an exemplary graphical user interface incorporates the interactive display 400. As described above, the interactive display 400 may be generated by a display generation module, such as that described with respect to FIG. 2 above. As illustrated in FIG. 5A, a graphical representation of an event sequence 404 may be included in the interactive display 400. The graphical representation of the event sequence 404 may include real-time event elements. In various implementations, the real-time event elements may graphically represent real-time event actions (e.g., as received by capturing module 154, such as that described with respect to FIG. 2).

As illustrated in FIG. 5A, an interactive element may be configured to cause the interactive display 400 to update the one or more real-time event elements in response to one or more user interactions (e.g., a mouse click or the like). As illustrated, the graphical representation of the event sequence 404 associated with a game identifier of a particular game (e.g., basketball game) may be filtered according to pre-determined time frames. As illustrated, upon a user interaction with a full game time frame button 402, the graphical representation of the event sequence 404 may be updated to display the event sequence of the full game associated with the game identifier.

As illustrated in FIG. 5A, interactive display 400 may include one or more a graphical representation of game statistic tab 406. As illustrated, a “Team Stats” tab, when selected by a user interaction, may display one or more graphical representations of the real-time event data. In examples, such graphical representations of the real-time event data may include a side-by-side comparison of team statistics such as points scored and the like.

As illustrated in FIG. 5B, an event element slider 414 of the interactive display 410 may cause the graphical representation of the event sequence to update in response to one or more user interactions. Upon a user interaction (e.g., dragging the slider from one side of the graphical representation of the event sequence to another side) with the event element slider 414, the real-time event elements may be filtered, selected, displayed in an updated manner, or the like. In various implementations, selecting one or more real-time event elements by interacting with the event element slider 414 may cause a graphical representation of a game statistic tab 416 to update based on the selected event elements. For example, a graphical representation of points scored may update to include only those points scored included within the selected one or more real-time event elements.

As described above, with respect to FIG. 5A, a user interaction with a time frame button 412 may cause the graphical representation of the event sequence to update according to the user-selected filters.

As illustrated in FIG. 5C, an exemplary graphical user interface incorporates the interactive display 420. As described above, the interactive display 420 may be generated by a display generation module, such as that described with respect to FIG. 2 above. As illustrated in FIG. 5C, a graphical representation of an event sequence 423 may be included in the interactive display 420. The graphical representation of the event sequence 423 may include real-time event elements 424. In various implementations, the real-time event elements 424 may graphically represent real-time event actions (e.g., as received by capturing module 154, such as that described with respect to FIG. 2).

As illustrated in FIG. 5C, interactive elements 421 may be configured to cause the interactive display 420 to update the one or more real-time event elements 424 in response to one or more user interactions (e.g., a mouse click or the like). As illustrated, the graphical representation of the event sequence 423 associated with a game identifier of a particular game (e.g., basketball game) may be filtered according to pre-determined time frames. As illustrated, upon a user interaction with a full game time frame button 421, the graphical representation of the event sequence 423 may be updated to display the event sequence of the full game associated with the game identifier.

As illustrated in FIG. 5C, interactive display 420 may include one or more graphical representations of game statistic tabs 426. As illustrated, a “Team Stats” tab, when selected by a user interaction, may display one or more graphical representations of the real-time event data. In examples, such graphical representations of the real-time event data may include a side-by-side comparison of team statistics such as points scored and the like.

In various embodiments, real-time data may be represented in the interactive display. In examples, as the user interacts with the interactive display, the data may update to reflect the selections made by the user. Such selections may include team statistics, player statistics, shot assist matrix, shot streaks, and player comparison data. When the shot streaks button is selected, the user can identify the player(s) or team making multiple successful shots in a row.

As illustrated in FIGS. 5D and 5E, an exemplary graphical user interface incorporates the interactive display 430. As described above, the interactive display 430 may be generated by a display generation module, such as that described with respect to FIG. 2 above. As illustrated in FIGS. 5D and 5E, the interactive display 430 may include a rotations button 432. When the rotations button 432 is selected by a user interaction, the interactive display 430 may show a graphical representation of player rotation data. In examples, the real-time game events may be filtered based on player involvements (e.g., who is or is not on the basketball court). In examples, the system 152 may gather, process, and/or generate player on/off court data. The player on/off court data may include real-time event data of each player. In examples, the player on/off court data may further include performance data of each player when one or more other players are on or off court.

In examples, when a bench button is un-checked as in FIG. 5D, only the players on the court may be displayed on the interactive display 430. When a bench button is checked as in FIG. 5E, all players may be displayed on the interactive display 430.

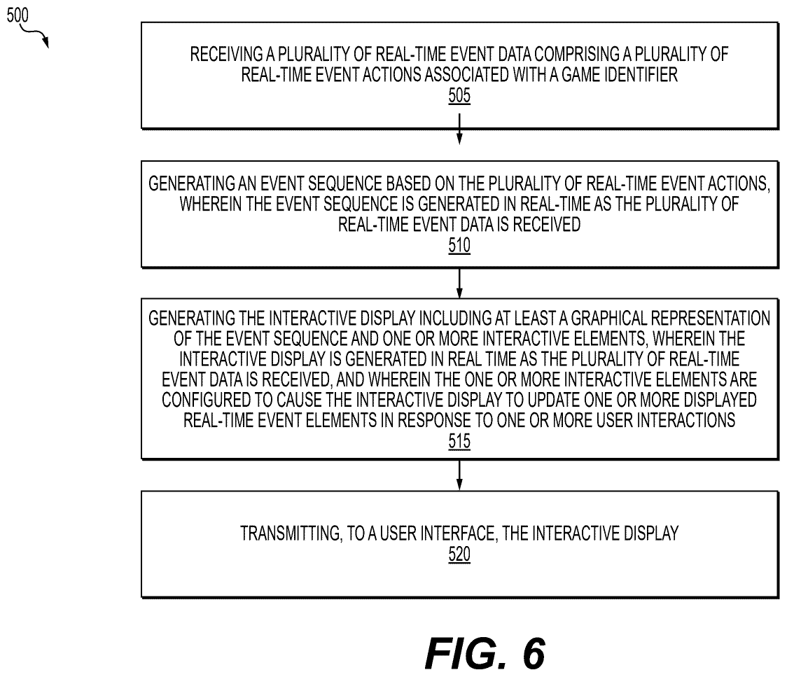

FIG. 6 illustrates a flowchart of an exemplary method for generating an interactive display. Exemplary method 500 begins with step 505, wherein a plurality of real-time event data comprising a plurality of real-time event actions associated with a game identifier are received (e.g., by capturing module 154 as depicted in FIG. 2). The plurality of real-time event actions may include one or more event actions associated with a game identifier such as, for example, a scored goal, a completed pass, an interception, a goal conceded, or the like. At step 510, an event sequence is generated based on the plurality of real-time event actions. The event sequence may be generated in real-time as the plurality of real-time event data is received.

At step 515, an interactive display is generated that includes at least a graphical representation of the event sequence and one or more interactive elements (e.g., by display generation module 157 as depicted in FIG. 2). The interactive display may be generated in real time as the plurality of real-time event data is received. The one or more interactive elements may be configured to cause the interactive display to update one or more displayed real-time event elements in response to one or more user interactions. In examples, the interactive display may be generated according to a set of filtering rules activated by the one or more user interactions. In such examples, the filtering rules may include filtering by event time, by one or more modes, as described above, or the like. In various embodiments, filtering by event time may represent a first filtering rule and filtering by one or more modes may represent a second filtering rule. In examples, the first filtering rule may correspond to displaying a first set of real-time event elements associated with a first event sequence period in response to a first user interaction. In examples, the second filtering rule may corresponding to displaying a first set of real-time event statistics associated with a first event sequence period in response to a first user interaction.

In various implementations, a scrolling interactive element (e.g., a slider) may be configured to cause the graphical representation of the event sequence to move one of forward in time or backward in time in response to the one or more user interactions, as described above. In examples, the interactive display may be generated anew in real-time as the plurality of real-time event data is received. At step 520, the interactive display is transmitted to a user interface (e.g., via network 160 to a display of user device 162 by transmission module 158, as depicted in FIG. 2).

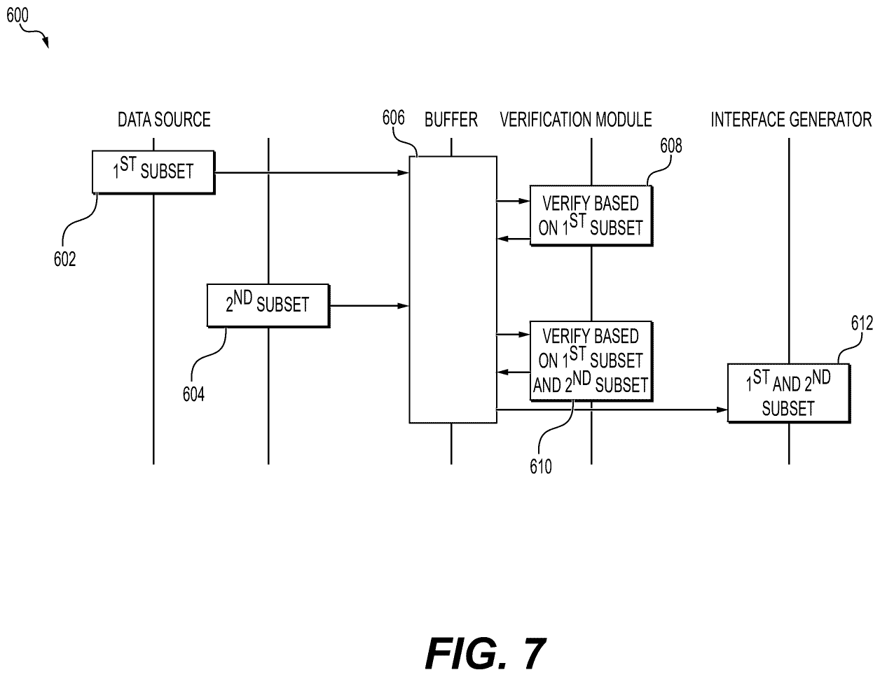

FIG. 7 depicts an exemplary data flow diagram 600 for generating an interactive display. One or more sets of real-time event data may be received (e.g., by capturing module 154, as described with respect to FIG. 2) in a first subset of data 602 and a second subset of data 604 from a data source (e.g., over network 160, as described with respect to FIG. 2). As illustrated, the first subset of data 602 and the second subset of data 604 may be placed in a buffer 606. In various implementations, buffer 606 may be operatively connected to interactive display computing system 152 or may be integrated within interactive display computing system 152 or one or more components of interactive display computing system 152.

The first subset of data 602 may be received at a first time and may be provided to buffer 606. Buffer 606 may verify the first subset of data 602 (e.g., via a verification module at 608) and may determine that the first subset of data 602 is incomplete. For example, buffer 606 may determine that the first subset of data 602 is missing values in a sequential counter, may determine that the first subset of data 602 has missing event data, may determine that the first subset of data 602 includes a chronologically subsequent portion of event data but not a chronologically prior portion of corresponding data, and/or the like. Based on determining that the first subset of data 602 is incomplete, the verification module may instruct buffer 606 to retain the first subset of data without transmitting it to an interface generator. As illustrated, the second subset of data 604 may be received at a second time after the first time. Buffer 606 may verify the first subset of data 602 and the second subset of data 604 (e.g., via a verification module at 610) and may determine that the first subset of data 602 plus the second subset of data 604 is complete. For example, buffer 606 may determine that the first subset of data 602 plus second subset of data 604 includes a complete counter, may determine that the first subset of data 602 plus second subset of data 604 has complete event data, may determine that the first subset of data 602 plus second subset of data 604 includes all sequential portions of a given event, and/or the like. Based on determining that the first subset of data 602 plus the second subset of data 604 is complete, the verification module may instruct buffer 606 to transmit the first subset of data 602 and the second subset of data 604 to the interface generator at 612 (e.g., to display generation module 157, as described with respect to FIG. 2). Accordingly, the data flow diagram 600 depicts techniques to ensure that a complete set of data is received (e.g., from multiple sources) prior to providing the event data for visualization and filtering via display generation module 157. Such techniques may ensure that partial data is not depicted via display generation module 157.

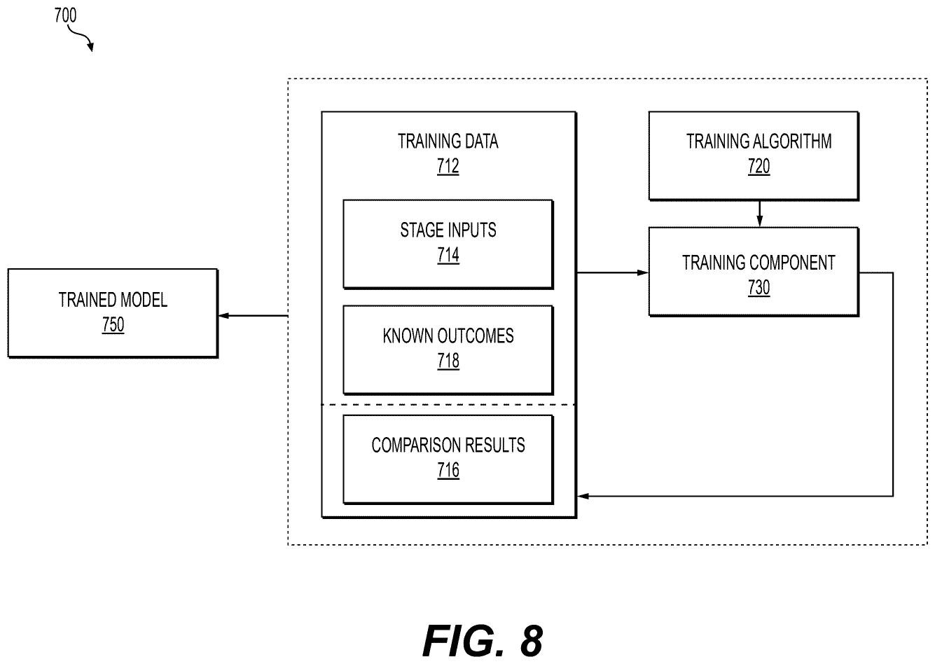

FIG. 8 depicts a flow diagram for training a machine-learning model. As shown in flow diagram 700 of FIG. 8, training data 712 may include one or more of stage inputs 714 and known outcomes 718 related to a machine-learning model to be trained. The stage inputs 714 may be from any applicable source including a component or set shown in the figures provided herein. The known outcomes 718 may be included for machine-learning models generated based on supervised or semi-supervised training. An unsupervised machine-learning model might not be trained using known outcomes 718. Known outcomes 718 may include known or desired outputs for future inputs similar to or in the same category as stage inputs 714 that do not have corresponding known outputs.

The training data 712 and a training algorithm 720 may be provided to a training component 730 that may apply the training data 712 to the training algorithm 720 to generate a trained machine-learning model 750. According to an implementation, the training component 730 may be provided comparison results 716 that compare a previous output of the corresponding machine-learning model to apply the previous result to re-train the machine-learning model. The comparison results 716 may be used by the training component 730 to update the corresponding machine-learning model. The training algorithm 720 may utilize machine-learning networks and/or models including, but not limited to a deep learning network such as Graph Neural Networks (GNN), Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 700 may be a trained machine-learning model 750.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

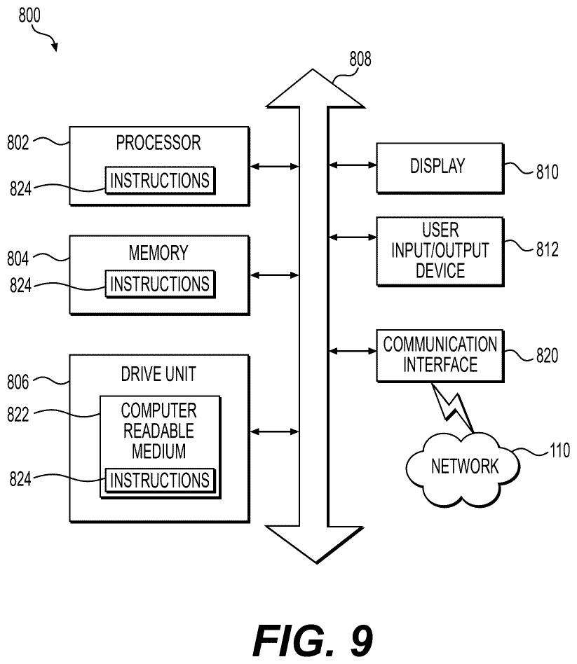

FIG. 9 is a simplified functional block diagram of a computer 800 that may be configured as a device for executing the methods disclosed here, according to exemplary aspects of the present disclosure. For example, the computer 800 may be configured as a system according to exemplary aspects of this disclosure. In various aspects, any of the systems herein may be a computer 800 including, for example, a data communication interface 820 for packet data communication. The computer 800 also may include a central processing unit (“CPU”) 802, in the form of one or more processors, for executing program instructions. The computer 800 may include an internal communication bus 808, and a storage unit 806 (such as ROM, HDD, SDD, etc.) that may store data on a computer readable medium 822, although the computer 800 may receive programming and data via network communications.

The computer 800 may also have a memory 804 (such as RAM) storing instructions 824 for executing techniques presented herein, for example the systems and methods described with respect to FIGS. 1-8, although the instructions 824 may be stored temporarily or permanently within other modules of computer 800 (e.g., processor 802 and/or computer readable medium 822). The computer 800 also may include input and output ports 812 and/or a display 810 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

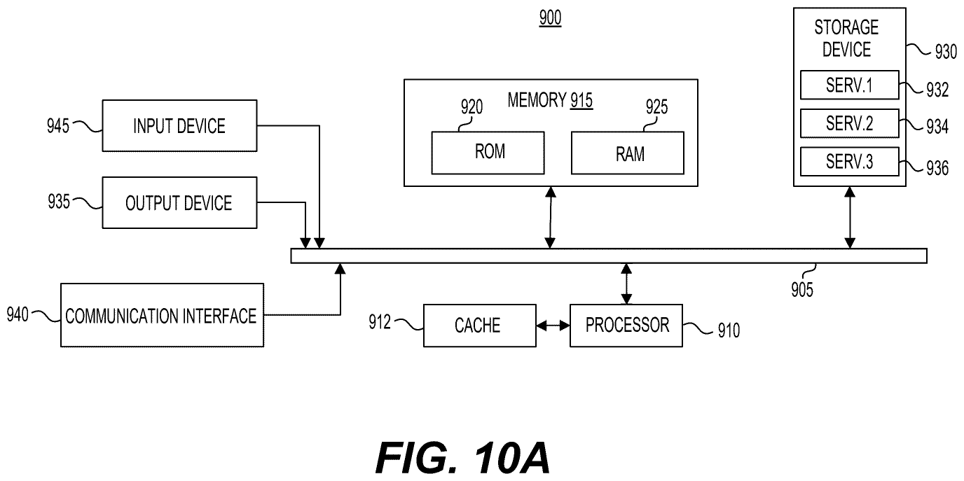

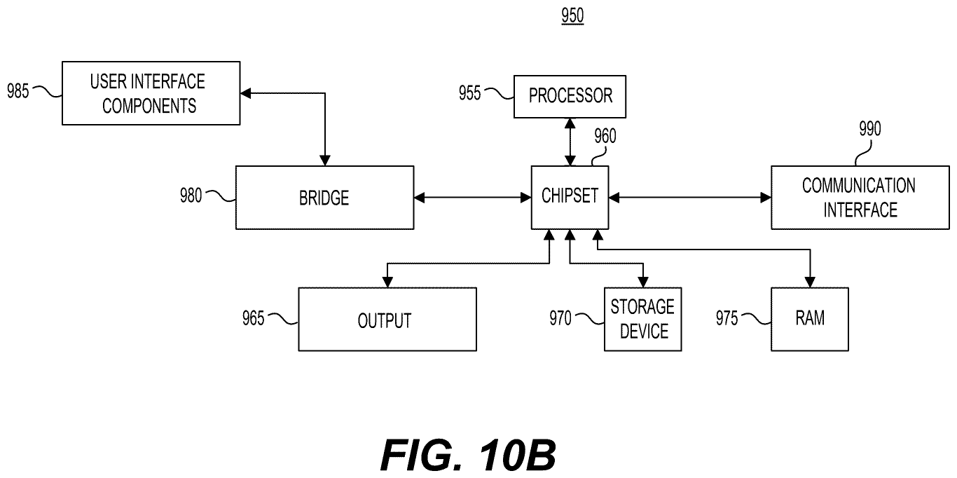

FIG. 10A illustrates an architecture of computing system 900, according to example embodiments. System 900 may be representative of at least a portion of organization computing system 104. One or more components of system 900 may be in electrical communication with each other using a bus 905. System 900 may include a processing unit (CPU or processor) 910 and a system bus 905 that couples various system components including the system memory 915, such as read only memory (ROM) 920 and random access memory (RAM) 925, to processor 910. System 900 may include a cache of high-speed memory connected directly with, in close proximity to, or integrated as part of processor 910. System 900 may copy data from memory 915 and/or storage device 930 to cache 912 for quick access by processor 910. In this way, cache 912 may provide a performance boost that avoids processor 910 delays while waiting for data. These and other modules may control or be configured to control processor 910 to perform various actions. Other system memory 915 may be available for use as well. Memory 915 may include multiple different types of memory with different performance characteristics. Processor 910 may include any general purpose processor and a hardware module or software module, such as service 1 932, service 2 934, and service 3 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction with the computing system 900, an input device 945 may represent any number of input mechanisms, such as a microphone for speech, a touch-sensitive screen for gesture or graphical input, keyboard, mouse, motion input, speech and so forth. An output device 935 (e.g., display) may also be one or more of a number of output mechanisms known to those of skill in the art. In some instances, multimodal systems may enable a user to provide multiple types of input to communicate with computing system 900. Communications interface 940 may generally govern and manage the user input and system output. There is no restriction on operating on any particular hardware arrangement and therefore the basic features here may easily be substituted for improved hardware or firmware arrangements as they are developed.

Storage device 930 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 925, read only memory (ROM) 920, and hybrids thereof.

Storage device 930 may include services 932, 934, and 936 for controlling the processor 910. Other hardware or software modules are contemplated. Storage device 930 may be connected to system bus 905. In one aspect, a hardware module that performs a particular function may include the software component stored in a computer-readable medium in connection with the necessary hardware components, such as processor 910, bus 905, output device 935, and so forth, to carry out the function.

FIG. 10B illustrates a computer system 950 having a chipset architecture that may represent at least a portion of organization computing system 104. Computer system 950 may be an example of computer hardware, software, and firmware that may be used to implement the disclosed technology. System 950 may include a processor 955, representative of any number of physically and/or logically distinct resources capable of executing software, firmware, and hardware configured to perform identified computations. Processor 955 may communicate with a chipset 960 that may control input to and output from processor 955. In this example, chipset 960 outputs information to output 965, such as a display, and may read and write information to storage device 970, which may include magnetic media, and solid-state media, for example. Chipset 960 may also read data from and write data to RAM 975. A bridge 980 for interfacing with a variety of user interface components 985 may be provided for interfacing with chipset 960. Such user interface components 985 may include a keyboard, a microphone, touch detection and processing circuitry, a pointing device, such as a mouse, and so on. In general, inputs to system 950 may come from any of a variety of sources, machine generated and/or human generated.

Chipset 960 may also interface with one or more communication interfaces 990 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 955 analyzing data stored in storage device 970 or RAM 975. Further, the machine may receive inputs from a user through user interface components 985 and execute appropriate functions, such as browsing functions by interpreting these inputs using processor 955.

It may be appreciated that example systems 900 and 950 may have more than one processor 910 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for generating an interactive display, the method comprising:
receiving, by one or more processors, a plurality of real-time event data comprising a plurality of real-time event actions associated with a game identifier;
generating, by the one or more processors, an event sequence based on the plurality of real-time event actions, wherein the event sequence is generated in real-time as the plurality of real-time event data is received;
generating, by the one or more processors, the interactive display including at least a graphical representation of the event sequence, including one or more real-time event elements, and one or more interactive elements, wherein the interactive display is formatted in real time as the plurality of real-time event data is received, and wherein the one or more interactive elements are configured to cause the interactive display to update the one or more real-time event elements in response to one or more user interactions; and
transmitting, to a user interface and by the one or more processors, the interactive display.

2. The computer-implemented method of claim 1, wherein the interactive display is generated according to a set of filtering rules.

3. The computer-implemented method of claim 2, wherein the set of filtering rules comprise a first filtering rule, the first filtering rule corresponding to displaying a first set of real-time event elements associated with a first event sequence period in response to a first user interaction.

4. The computer-implemented method of claim 2, wherein the set of filtering rules comprise a second filtering rule, the second filtering rule corresponding to displaying a first set of real-time event statistics associated with a first event sequence period in response to a first user interaction.

5. The computer-implemented method of claim 1, wherein the plurality of real-time event actions include at least one of a scored goal, a completed pass, an interception, a goal conceded, or no action.

6. The computer-implemented method of claim 1, further comprising:
receiving, by the one or more processors, a first subset of real-time event data of the plurality of real-time event data; and
providing, by the one or more processors, the first subset of real-time event data to a buffer.

7. The computer-implemented method of claim 6, further comprising:
receiving, by the one or more processors, a second subset of real-time event data of the plurality of real-time event data;
providing, by the one or more processors, the second subset of real-time event data to the buffer; and
determining, by the one or more processors, that the plurality of real-time event data is completed based on the first subset of real-time event data and the second subset of real-time event data.

8. A system for generating an interactive display, the system comprising:
a memory storing instructions and a processor operatively connected to the memory and configured to execute the instructions to perform operations including:
receiving, by one or more processors, a plurality of real-time event data comprising a plurality of real-time event actions associated with a game identifier;
generating, by the one or more processors, an event sequence based on the plurality of real-time event actions, wherein the event sequence is generated in real-time as the plurality of real-time event data is received;
generating, by the one or more processors, the interactive display including at least a graphical representation of the event sequence, including one or more real-time event elements, and one or more interactive elements, wherein the interactive display is formatted in real time as the plurality of real-time event data is received, and wherein the one or more interactive elements are configured to cause the interactive display to update the one or more real-time event elements in response to one or more user interactions; and
transmitting, to a user interface and by the one or more processors, the interactive display.

9. The system of claim 8, wherein the interactive display is generated according to a set of filtering rules.

10. The system of claim 9, wherein the set of filtering rules comprise a first filtering rule, the first filtering rule corresponding to displaying a first set of real-time event elements associated with a first event sequence period in response to a first user interaction.

11. The system of claim 9, wherein the set of filtering rules comprise a second filtering rule, the second filtering rule corresponding to displaying a first set of real-time event statistics associated with a first event sequence period in response to a first user interaction.

12. The system of claim 8, wherein the plurality of real-time event actions include at least one of a scored goal, a completed pass, an interception, a goal conceded, or no action.

13. The system of claim 8, wherein the one or more interactive elements are configured to cause the graphical representation of the event sequence to update in response to the one or more user interactions.

14. The system of claim 8, wherein a scrolling interactive element is configured to cause the graphical representation of the event sequence to move one of forward in time or backward in time in response to the one or more user interactions.

15. A non-transitory computer-readable medium storing instructions that, when executed by one or more processors, perform operations including:
receiving, by one or more processors, a plurality of real-time event data comprising a plurality of real-time event actions associated with a game identifier;
generating, by the one or more processors, an event sequence based on the plurality of real-time event actions, wherein the event sequence is generated in real-time as the plurality of real-time event data is received;
generating, by the one or more processors, an interactive display including at least a graphical representation of the event sequence, including one or more real-time event elements, and one or more interactive elements, wherein the interactive display is formatted in real time as the plurality of real-time event data is received, and wherein the one or more interactive elements are configured to cause the interactive display to update the one or more real-time event elements in response to one or more user interactions; and
transmitting, to a user interface and by the one or more processors, the interactive display.

16. The non-transitory computer-readable medium of claim 15, wherein the interactive display is generated according to a set of filtering rules.

17. The non-transitory computer-readable medium of claim 16, wherein the set of filtering rules comprise a first filtering rule, the first filtering rule corresponding to displaying a first set of real-time event elements associated with a first event sequence period in response to a first user interaction.

18. The non-transitory computer-readable medium of claim 16, wherein the set of filtering rules comprise a second filtering rule, the second filtering rule corresponding to displaying a first set of real-time event statistics associated with a first event sequence period in response to a first user interaction.

19. The non-transitory computer-readable medium of claim 15, wherein the one or more interactive elements are configured to cause the graphical representation of the event sequence to update in response to the one or more user interactions.

20. The non-transitory computer-readable medium of claim 15, wherein a scrolling interactive element is configured to cause the graphical representation of the event sequence to move one of forward in time or backward in time in response to the one or more user interactions.
